(19) United States
(12) Patent Application Publication
(10) Pub. No.: US 2020/0207275 A1
(43) Pub. Date: Jul. 2, 2020

(54) LATERAL REAR IMAGE CONTROL APPARATUS AND LATERAL REAR IMAGE CONTROL METHOD

(71) Applicant: Mitsubishi Electric Corporation, Tokyo (JP)

(72) Inventors: Mitsuo SHIMOTANI, Tokyo (JP); Yoshitaka NAKAMURA, Tokyo (JP); Yoshiharu ASAGA, Tokyo (JP)

(73) Assignee: Mitsubishi Electric Corporation, Tokyo (JP)

(21) Appl. No.: 16/638,281

(22) PCT Filed: Sep. 22, 2017
(86) PCT No.: PCT/JP2017/034299

§ 371 Date: Feb. 11, 2020

(51) Int. Cl. B60R 1/12; H04N 7/18; B60R 1/08; B60R 11/04

(52) U.S. Cl. CPC B60R 1/12; H04N 7/181; B60R 1/08; B60R 2300/804; B60R 2001/1253; B60R 2300/605; B60R 2300/8066; B60R 11/04

(57) ABSTRACT

It is an object of the present invention to allow a driver to appropriately view a travel lane and an adjacent lane behind a vehicle regardless of the shape of the travel lane. A lateral rear image control apparatus controls a lateral rear image display apparatus, and includes: a lane shape acquisition unit to acquire information on the shape of the travel lane of the subject vehicle; a viewing range setting unit to set, based on the information on the shape of the travel lane behind the subject vehicle, a region located in a particular direction relative to the subject vehicle at the lateral rear of the subject vehicle to a recommended viewing range; and a controller to control the lateral rear image display apparatus so that an image in the recommended viewing range is displayed to the driver.

### TECHNICAL FIELD

The present invention relates to technology for controlling display of a lateral rear image to a driver of a vehicle.

### BACKGROUND ART

A driver uses a lateral rear image display apparatus, such as a mirror, as a means of looking a lateral rear of a vehicle. An orientation of the mirror can be adjusted through operation of the driver, and is adjusted so that an image in a reference viewing range set relative to the location of the vehicle can be viewed.

Patent Document 1 discloses a lateral rear image display apparatus allowing a driver to view a condition in a travel lane and an adjacent lane when a vehicle travels on a straight road. In technology disclosed in Patent Document 1, however, the travel lane of a subject vehicle and the adjacent lane cannot be viewed in some cases when the vehicle travels on a curve.

In contrast, in Patent Document 2, an attempt is made to estimate curvature of a curve of a lane from a travel path and the like of a vehicle, estimate the shape of a road based on the curvature, and orient a rear viewing apparatus so that the rear viewing apparatus displays a travel lane at the rear.

### PRIOR ART DOCUMENTS

### Patent Documents

Patent Document 1: Japanese Patent Application Laid-Open No. 2015-144407

Patent Document 2: Japanese Patent Application Laid-Open No. 2009-280196

### SUMMARY

### Problem to be Solved by the Invention

The vehicle, however, does not always travel on the curve along the shape of the lane, and thus an error can be caused when the shape of the lane is acquired from the travel path of the vehicle. This causes a problem in that the driver cannot appropriately view the travel lane and the adjacent lane behind the vehicle.

The present invention has been conceived in view of the above-mentioned problem, and it is an object of the present invention to allow a driver to appropriately view a travel lane and an adjacent lane behind a vehicle regardless of the shape of the travel lane.

### Means to Solve the Problem

A lateral rear image control apparatus of the present invention is a lateral rear image control apparatus controlling a lateral rear image display apparatus displaying an image at a lateral rear of a subject vehicle to a driver, and includes: a lane shape acquisition unit to acquire information on a shape of a travel lane of the subject vehicle; a viewing range setting unit to set, based on the information on the shape of the travel lane behind the subject vehicle, a region located in a particular direction relative to the subject vehicle at the lateral rear of the subject vehicle to a recommended viewing range; and a controller to control the lateral rear image display apparatus so that an image in the recommended viewing range is displayed to the driver.

A lateral rear image control method of the present invention is a lateral rear image control method of controlling a lateral rear image display apparatus displaying an image at a lateral rear of a subject vehicle to a driver, and includes: acquiring information on a shape of a travel lane of the subject vehicle; setting, based on the information on the shape of the travel lane behind the subject vehicle, a region located in a particular direction relative to the subject vehicle at the lateral rear of the subject vehicle to a recommended viewing range; and controlling the lateral rear image display apparatus so that an image in the recommended viewing range is displayed to the driver.

### Effects of the Invention

The lateral rear image control apparatus of the present invention is a lateral rear image control apparatus controlling a lateral rear image display apparatus displaying an image at a lateral rear of a subject vehicle to a driver, and includes: a lane shape acquisition unit to acquire information on a shape of a travel lane of the subject vehicle; a viewing range setting unit to set, based on the information on the shape of the travel lane behind the subject vehicle, a region located in a particular direction relative to the subject vehicle at the lateral rear of the subject vehicle to a recommended viewing range; and a controller to control the lateral rear image display apparatus so that an image in the recommended viewing range is displayed to the driver. The driver can thereby appropriately view the travel lane and the adjacent lane behind the vehicle regardless of the shape of the travel lane.

The lateral rear image control method of the present invention is a lateral rear image control method of controlling a lateral rear image display apparatus displaying an image at a lateral rear of a subject vehicle to a driver, and includes: acquiring information on a shape of a travel lane of the subject vehicle; setting, based on the information on the shape of the travel lane behind the subject vehicle, a region located in a particular direction relative to the subject vehicle at the lateral rear of the subject vehicle to a recommended viewing range; and controlling the lateral rear image display apparatus so that an image in the recommended viewing range is displayed to the driver. The driver can thereby appropriately view the travel lane and the adjacent lane behind the vehicle regardless of the shape of the travel lane.

The objects, features, aspects, and advantages of the present invention will become more apparent from the following detailed description and the accompanying drawings.

### BRIEF DESCRIPTION OF DRAWINGS

FIG. 1 is a block diagram of a lateral rear image display system in Embodiment 1.

FIG. 2 is a flowchart showing operation of the lateral rear image display system in Embodiment 1.

FIG. 3 is a block diagram of a lateral rear image display system in Embodiment 2.

FIG. 4 illustrates locations of electric mirrors in a subject vehicle.

FIG. 5 illustrates reference viewing ranges.

FIG. 6 illustrates a display screen of a lateral rear image display apparatus displaying an image in a reference viewing range.

FIG. 7 illustrates a positional relationship between a reference viewing range and a non-subject vehicle when the subject vehicle travels on a straight road.

FIG. 8 illustrates an image displayed on an electric mirror in the positional relationship illustrated in FIG. 7.

FIG. 9 illustrates a positional relationship between the reference viewing range and the non-subject vehicle when the subject vehicle travels on a curved road.

FIG. 10 illustrates an image displayed on the electric mirror in the positional relationship illustrated in FIG. 9.

FIG. 11 is a conceptual diagram for estimating the shape of a travel lane based on a track of the subject vehicle.

FIG. 12 illustrates a method of setting a recommended viewing range.

FIG. 13 illustrates the display screen of the lateral rear image display apparatus in the positional relationship illustrated in FIG. 10.

FIG. 14 is a flowchart showing operation of the lateral rear image display system in Embodiment 2.

FIG. 15 illustrates an example of adjustment of an orientation of the electric mirror.

FIG. 16 illustrates the recommended viewing range when the subject vehicle travels in a lane having a grade.

FIG. 17 illustrates the recommended viewing range when the subject vehicle travels in the lane having the grade.

FIG. 18 illustrates an electric mirror in a modification of Embodiment 2.

FIG. 19 is a block diagram showing a configuration of a lateral rear image display system in Embodiment 3.

FIG. 20 is a block diagram showing a configuration of a lateral rear image display system in Embodiment 4.

FIG. 21 illustrates a cropping range of an image captured by a wide-angle camera.

FIG. 22 illustrates an image captured by the wide-angle camera when the subject vehicle travels in a straight lane.

FIG. 23 illustrates an image displayed on a monitor.

FIG. 24 illustrates an image captured by the wide-angle camera when the subject vehicle travels in a curved lane.

FIG. 25 illustrates an image displayed on the monitor.

FIG. 26 illustrates cropping ranges of the image captured by the wide-angle camera when the subject vehicle travels in the curved lane.

FIG. 27 illustrates an image displayed on the monitor.

FIG. 28 illustrates an image displayed on the monitor.

FIG. 29 illustrates trapezoidal cropping ranges.

FIG. 30 is a block diagram showing a configuration of a lateral rear image control system in Embodiment 5.

FIG. 31 illustrates installation locations of cameras in the subject vehicle.

FIG. 32 illustrates a combined image acquired by a combination unit.

FIG. 33 illustrates a combined image acquired by the combination unit.

FIG. 34 is a block diagram showing a configuration of a lateral rear image display system in Embodiment 6.

FIG. 35 illustrates a perfect circular roundabout.

FIG. 36 is a block diagram showing a configuration of a lateral rear image display system in Embodiment 7.

FIG. 37 is a flowchart showing operation of the lateral rear image display system in Embodiment 7.

FIG. 38 illustrates the recommended viewing range.

FIG. 39 illustrates an orientation of a camera.

FIG. 40 illustrates an image displayed on the monitor.

FIG. 41 is a block diagram showing a configuration of a lateral rear image display system in Embodiment 8.

FIG. 42 illustrates installation locations of cameras in the subject vehicle.

FIG. 43 illustrates a panoramic image.

FIG. 44 illustrates a panoramic image.

FIG. 45 is a block diagram showing a configuration of a lateral rear image control system in Embodiment 9.

FIG. 46 is a flowchart showing operation of the lateral rear image control system in Embodiment 9.

FIG. 47 illustrates a recommended viewing region and an orientation of an electric mirror when the subject vehicle makes a left turn at an intersection.

FIG. 48 shows a hardware configuration of a lateral rear image control apparatus.

FIG. 49 shows a hardware configuration of the lateral rear image control apparatus.

FIG. 50 shows an example of a lateral rear image control apparatus in Embodiment 1 configured by the subject vehicle and a server.

### DESCRIPTION OF EMBODIMENTS

### Embodiment 1

FIG. 1 is a block diagram showing a configuration of a lateral rear image display system in Embodiment 1. The lateral rear image display system in Embodiment 1 includes a lateral rear image control apparatus 101 and a lateral rear image display apparatus 21.

The lateral rear image display apparatus 21 is mounted on a subject vehicle, and displays an image at a lateral rear of the subject vehicle to a driver of the subject vehicle. In the present description, a vehicle on which the lateral rear image display apparatus is mounted is referred to as a “subject vehicle”, and any vehicle other than the subject vehicle is referred to as a “non-subject vehicle” to distinguish between them.

The lateral rear image control apparatus 101 is an apparatus controlling display of the lateral rear image display apparatus 21. The lateral rear image control apparatus 101 includes a lane shape acquisition unit 11, a viewing range setting unit 12, and a controller 13.

The lane shape acquisition unit 11 acquires information on the shape of a travel lane of the subject vehicle. The information on the shape of the travel lane includes at least one of information on a horizontal shape and information on a vertical shape of the travel lane. The information on the horizontal shape of the travel lane may be expressed in any manner that is mathematical or used in a map database. The information on the horizontal shape of the travel lane may be expressed, for example, using a two-dimensional point coordinate array set, a geometrical expression such as a clothoid, and curvature relating to a circle. The information on the vertical shape of the travel lane may be information on a grade, for example, and may be expressed mathematically as with the information on the horizontal shape. A vertical change may be expressed using the curvature. The shape of the travel lane may be a three-dimensional shape, and may be expressed using a three-dimensional point coordinate array set or a mathematical three-dimensional function. The information on the horizontal shape and the information on the vertical shape of the travel lane may be expressed in different manners. The shape of the lane may be expressed to include a lane width. The shape of the travel lane may be expressed as a strip planar shape.

The viewing range setting unit 12 sets, based on the shape of the travel lane behind the subject vehicle, a region located in a direction in which a non-subject vehicle traveling in the travel lane or an adjacent lane behind the subject vehicle can be viewed at a lateral rear of the subject vehicle to a recommended viewing range. The lateral rear of the subject vehicle refers to a right rear and a left rear of the subject vehicle.

The controller 13 controls the lateral rear image display apparatus 21 so that an image in the recommended viewing range set by the viewing range setting unit 12 is displayed to the driver.

Upon controlled by the controller 13, the lateral rear image display apparatus 21 displays the image in the recommended viewing range to the driver. The driver can thereby view the image in the recommended viewing range.

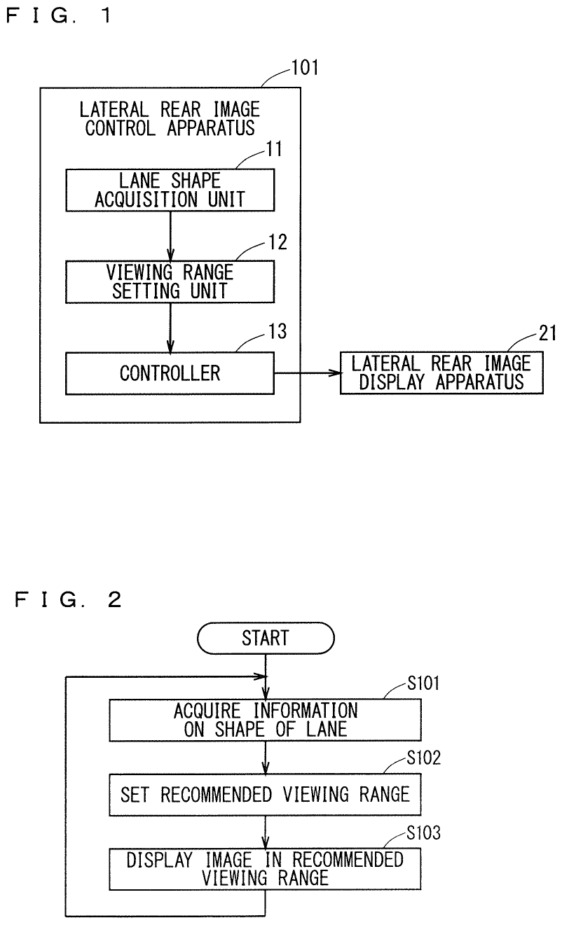

FIG. 2 is a flowchart showing operation of the lateral rear image display system in Embodiment 1. The operation of the lateral rear image display system in Embodiment 1 will be described below with reference to FIG. 2. This flow starts at a timing of powering on of accessories of the subject vehicle, and continues until the accessories of the subject vehicle are powered off, for example. First, the lane shape acquisition unit 11 acquires the information on the shape of the travel lane (step S101). Next, the viewing range setting unit 12 sets the recommended viewing range (step S102). Then, the controller 13 controls the lateral rear image display apparatus 21 so that the image in the recommended viewing range is displayed to the driver (step S103), and the flow returns to the step S101.

### Effects of Embodiment 1

The lateral rear image control apparatus 101 in Embodiment 1 controls the lateral rear image display apparatus 21 displaying the image at the lateral rear of the subject vehicle to the driver. The lateral rear image control apparatus 101 includes the lane shape acquisition unit 11 to acquire the information on the shape of the travel lane of the subject vehicle; the viewing range setting unit 12 to set, based on the information on the shape of the travel lane behind the subject vehicle, a region located in a particular direction relative to the subject vehicle at the lateral rear of the subject vehicle to the recommended viewing range; and the controller 13 to control the lateral rear image display apparatus 21 so that the image in the recommended viewing range is displayed to the driver. As described above, the lateral rear image control apparatus 101 causes the lateral rear image display apparatus 21 to display the image in the recommended viewing range set based on the information on the shape of the travel lane of the subject vehicle to thereby allow the driver to view the non-subject vehicle traveling in the travel lane or the adjacent lane behind the subject vehicle regardless of whether the travel lane of the subject vehicle is straight or curved.

A lateral rear image control method in Embodiment 1 is a lateral rear image control method of controlling the lateral rear image display apparatus displaying the image at the lateral rear of the subject vehicle to the driver, and includes: acquiring the information on the shape of the travel lane of the subject vehicle; setting, based on the information on the shape of the travel lane behind the subject vehicle, the region located in the particular direction relative to the subject vehicle at the lateral rear of the subject vehicle to the recommended viewing range; and controlling the lateral rear image display apparatus so that the image in the recommended viewing range is displayed to the driver. As described above, according to the lateral rear image control method in Embodiment 1, the lateral rear image display apparatus 21 displays the image in the recommended viewing range set based on the information on the shape of the travel lane of the subject vehicle to thereby allow the driver to view the non-subject vehicle traveling in the travel lane or the adjacent lane behind the subject vehicle regardless of whether the travel lane of the subject vehicle is straight or curved.

### Embodiment 2

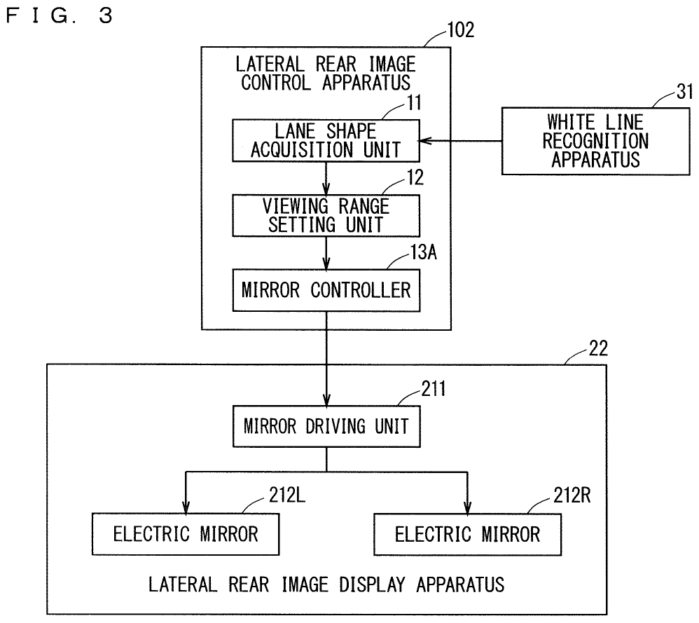

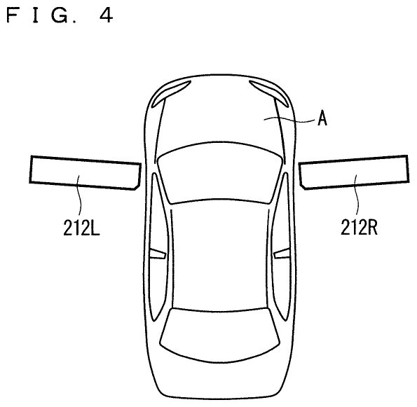

FIG. 3 is a block diagram showing a configuration of a lateral rear image display system in Embodiment 2. The lateral rear image display system in Embodiment 2 includes a lateral rear image control apparatus 102, a lateral rear image display apparatus 22, and a white line recognition apparatus 31. In FIG. 3, components being the same as or corresponding to components in the other embodiments bear the same reference signs as those of the same or corresponding components. The lateral rear image control apparatus 102 includes the lane shape acquisition unit 11, the viewing range setting unit 12, and a mirror controller 13A.

The white line recognition apparatus 31 captures an image around the subject vehicle using a camera mounted on the subject vehicle, and performs image recognition on the captured image to recognize the shapes of white lines of the travel lane of the subject vehicle or the adjacent lane. The white line recognition apparatus 31 outputs a result of recognition of the shapes of the white lines as white line recognition information to the lane shape acquisition unit 11.

The lane shape acquisition unit 11 acquires the shape of the travel lane of the subject vehicle or the adjacent lane based on the white line recognition information acquired from the white line recognition apparatus 31.

The viewing range setting unit 12 acquires the shape of the lane from the lane shape acquisition unit 11, and sets the recommended viewing range based on the shape of the travel lane behind the subject vehicle. The viewing range setting unit 12 also sets a region located in a particular direction relative to the subject vehicle at the lateral rear of the subject vehicle to a reference viewing range.

The mirror controller 13A controls a mirror driving unit 211 of the lateral rear image display apparatus 22 so that an image in the reference viewing range or the image in the recommended viewing range is displayed to the driver.

The lateral rear image display apparatus 22 includes the mirror driving unit 211 and electric mirrors 212L and 212R. As illustrated in FIG. 4, the electric mirror 212L is mounted on a front side of a left door of a subject vehicle A, and reflects an image at the left rear of the subject vehicle A in a mirror surface to display it to the driver. The electric mirror 212R is mounted on a front side of a right door of the subject vehicle A, and reflects an image at the right rear of the subject vehicle A in a mirror surface to display it to the driver. Orientations of the electric mirrors 212L and 212R are set by the mirror controller 13A, and adjusted by the mirror driving unit 211 under control of the mirror controller 13A. Letters L and R in the reference signs of the electric mirrors 212L and 212R respectively represent left and right. The same applies to other components bearing reference signs including the letters L and R. The electric mirrors 212L and 212R are illustrated in FIG. 4 to have greater sizes for purposes of explanation, but actually have normal sizes of electric mirrors.

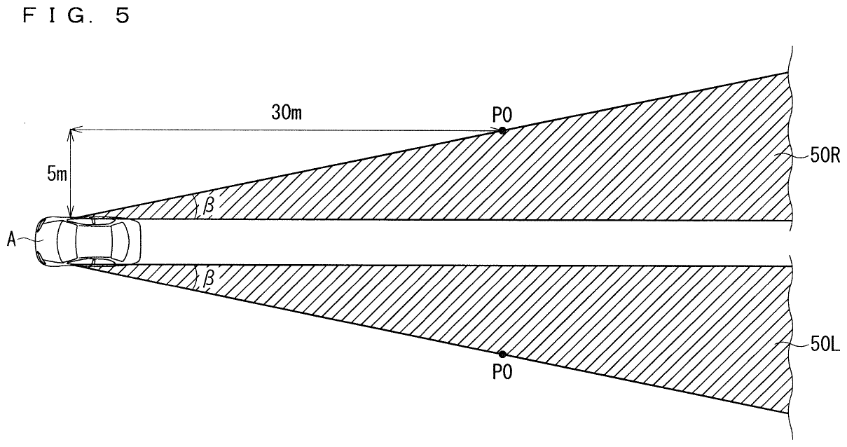

FIG. 5 illustrates reference viewing ranges. The reference viewing ranges are set at the right rear and the left rear of the subject vehicle A. When a point located 5 m to the right from and 30 m behind the subject vehicle A is set to a reference viewing point P0, a reference viewing range 50R at the right rear of the subject vehicle A is defined as a range between a line extending along a right side of the subject vehicle A and a line extending from the subject vehicle A to the reference viewing point P0. A reference viewing range 50L at the left rear of the subject vehicle A is a mirror image of the reference viewing range 50R with respect to the subject vehicle A. As described above, the locations of the reference viewing ranges are set relative to the subject vehicle A, and are fixed regardless of the shape of the travel lane of the subject vehicle A. In this example, the reference viewing ranges each have a viewing angle β of approximately 9.5° from an equation β=tan⁻¹(5/30). The reference viewing ranges are not limited to those illustrated in FIG. 5. For example, the reference viewing range 50L may not be the mirror image of the reference viewing range 50R with respect to the subject vehicle A. A desirable viewing range in a camera monitoring system is described in “Handbook of Camera Monitor Systems, The Automotive Mirror-Replacement Technology based on ISO 16505, Editors: Terzis, Anestis (Ed.)”, and the viewing range may be used as each of the reference viewing ranges.

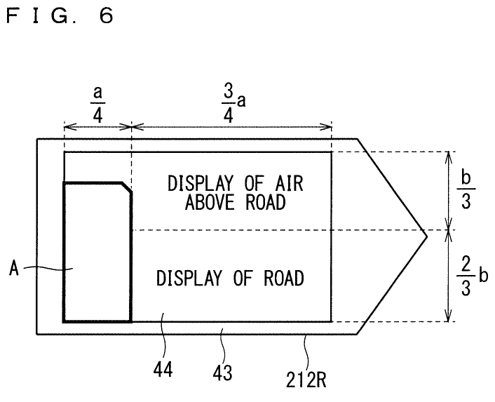

FIG. 6 illustrates an image displayed on the electric mirror 212R oriented in a reference viewing direction. In the present embodiment, a direction when an electric mirror displays the image in the reference viewing range is referred to as the reference viewing direction, and a direction when the electric mirror displays the image in the recommended viewing range is referred to as a recommended viewing direction. The electric mirrors 212L and 212R each include a housing 43 and a mirror surface 44. Assume that a horizontal dimension and a vertical dimension of the mirror surface 44 are respectively a and b. A right side surface of a body of the subject vehicle A is displayed in a region of a/4 from a left end of the mirror surface 44, and an image in the reference viewing range 50R is displayed in the remaining region. A road including the travel lane or the adjacent lane is displayed in a region of 2b/3 from a lower end of the mirror surface 44, and the air above the road is displayed in the remaining region. Although display on the electric mirror 212R is described herein, the same applies to display on the electric mirror 212L oriented in the reference viewing direction. While the image displayed on the electric mirror 212R is illustrated in FIG. 6, this is the image viewed when the driver of the subject vehicle A looks in the electric mirror 212R. The form of display of the image in the reference viewing range on the electric mirror is not limited to that illustrated in FIG. 6. For example, the road including the travel lane or the adjacent lane may be displayed in a region of b/3 from the lower end of the mirror surface 44, and the air above the road may be displayed in the remaining region.

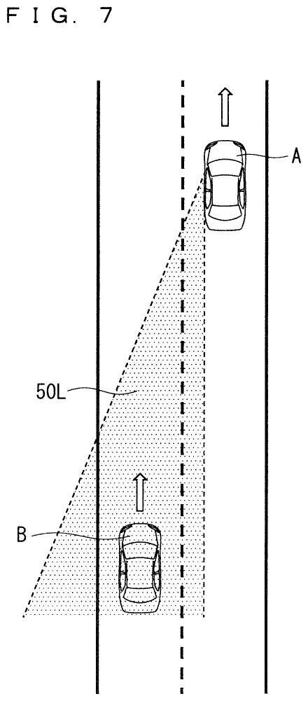

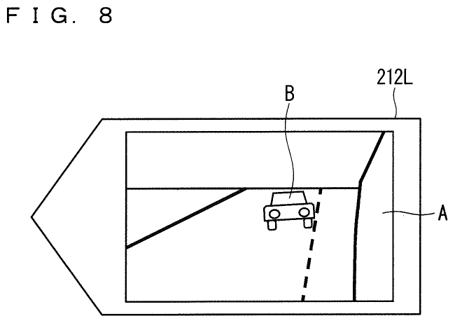

FIG. 7 illustrates a positional relationship between the reference viewing range 50L and a non-subject vehicle B when the subject vehicle A travels on a straight road. The subject vehicle A travels in a right lane of a straight two-lane road, and the non-subject vehicle B travels in a left lane at the left rear of the subject vehicle A. The location of the non-subject vehicle B is included in the reference viewing range 50L. The non-subject vehicle B is thus displayed on the electric mirror 212L as illustrated in FIG. 8.

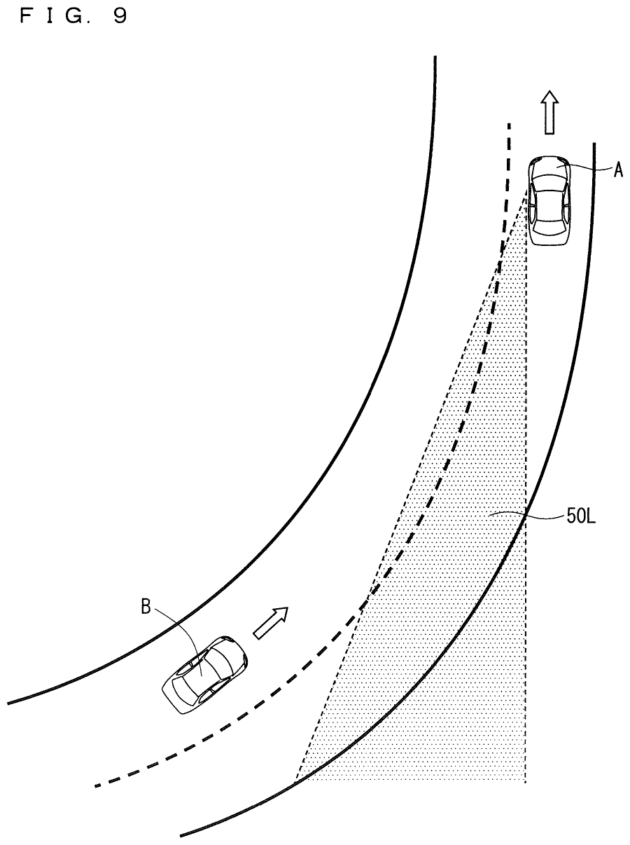

FIG. 9 illustrates a positional relationship between the reference viewing range 50L and the non-subject vehicle B when the subject vehicle A travels on a curved road. When the travel lane behind the subject vehicle A is curved, the location of the non-subject vehicle B is out of the reference viewing range 50L. If the orientation of the electric mirror 212L is fixed in the reference viewing direction, the non-subject vehicle B is not displayed on the electric mirror 212L as illustrated in FIG. 10. It is thus necessary to change the orientation of the electric mirror 212L in accordance with the shape of the travel lane behind the subject vehicle A to allow the driver to always view the non-subject vehicle B. In the present embodiment, a region located in a certain direction at the lateral rear of the subject vehicle is set to the recommended viewing range in accordance with the horizontal shape of the travel lane behind the subject vehicle A, and the lateral rear image display apparatus 21 displays the image in the recommended viewing range to thereby solve the above-mentioned problem.

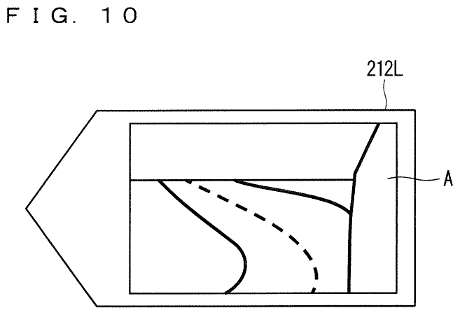

FIG. 11 illustrates comparison between a travel path of the subject vehicle A and the shape of the travel lane. The travel path of the subject vehicle A can be detected, for example, using various sensors, such as an acceleration sensor and a vehicle speed sensor, mounted on the subject vehicle A. The travel path of the subject vehicle A can be estimated to be the shape of the travel lane. The travel path of the subject vehicle A, however, is dependent on surrounding conditions, travel characteristics or a psychological state of the driver, and the like, and is thus not always along the shape of the travel lane as illustrated in FIG. 11. The travel path of the subject vehicle A can be an out-in-out path c1 or an in-out-in path c2. The lane shape acquisition unit 11 in the present embodiment thus accurately grasps the shape of the travel lane not by estimating the shape of the travel lane from the travel path of the subject vehicle A but by directly detecting or acquiring the shape of the travel lane.

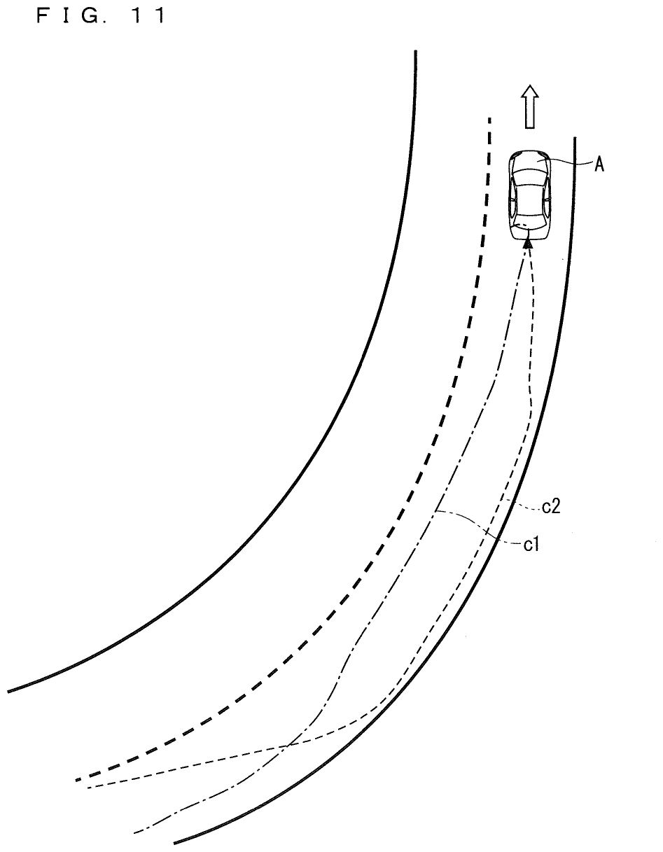

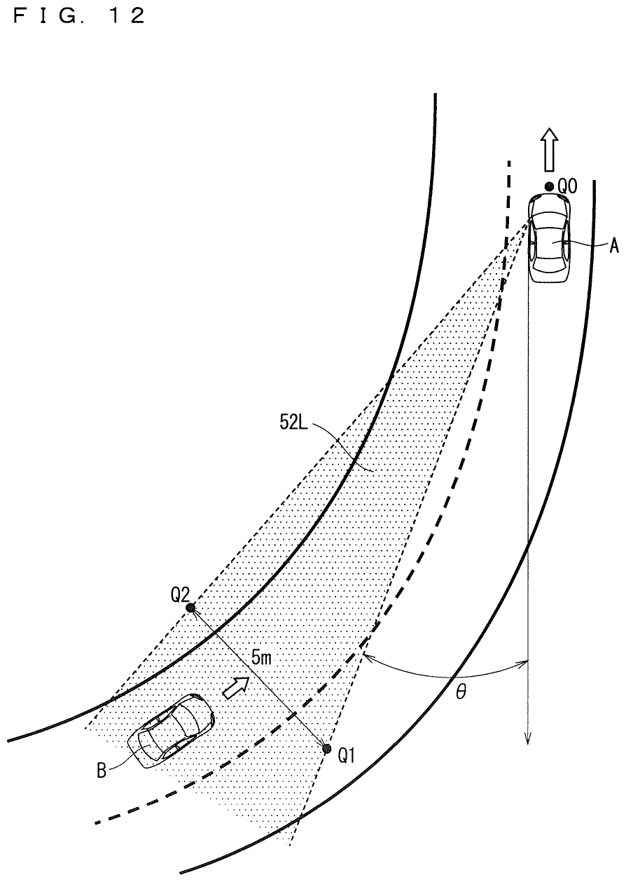

A method of setting the recommended viewing range will be described with reference to FIG. 12. First, the viewing range setting unit 12 sets a point located a first distance of 30 m back away from a head location Q0 of the subject vehicle A along the travel lane to a first recommended viewing point Q1. The viewing range setting unit 12 can set the first recommended viewing point Q1, for example, using information on curvature as one example of the information on the shape of the travel lane. Next, the viewing range setting unit 12 sets, to a second recommended viewing point Q2, a point located a second distance of 5 m away from the first recommended viewing point Q1 in a direction normal to the travel lane, that is to say, to the left relative to a direction of travel in the travel lane at the first recommended viewing point Q1. The viewing range setting unit 12 sets a range including the head location Q0, the first recommended viewing point Q1, and the second recommended viewing point Q2 to a recommended viewing range 52L at the left rear of the subject vehicle A. In this case, the non-subject vehicle B is displayed on the electric mirror 212L as illustrated in FIG. 13. While a method of setting the recommended viewing range 52L at the left rear of the subject vehicle A is described above, the same applies to a method of setting a recommended viewing range 52R at the right rear of the subject vehicle A. According to this setting method, the reference viewing range and the recommended viewing range are the same range when the travel lane of the subject vehicle A is straight. The second recommended viewing point Q2 is not limited to the point located away from the first recommended viewing point Q1 in the direction normal to the travel lane, and may not accurately be in the normal direction as long as it is in an outward direction of the direction of travel of the subject vehicle A relative to a line Q0-Q1. For example, the line Q0-Q1 and a line Q2-Q1 may form a right angle. Alternatively, as described on the reference viewing ranges in FIG. 5, the second recommended viewing point Q2 may be set so that the viewing angle β is formed relative to the line Q0-Q1.

Although described, with reference to FIG. 12, to be set relative to the head location Q0 of the subject vehicle A, the recommended viewing range may be set relative to another location of the subject vehicle A. For example, the recommended viewing range 52L may be set relative to the location of the electric mirror 212L, and the recommended viewing range 52R may be set relative to the location of the electric mirror 212R.

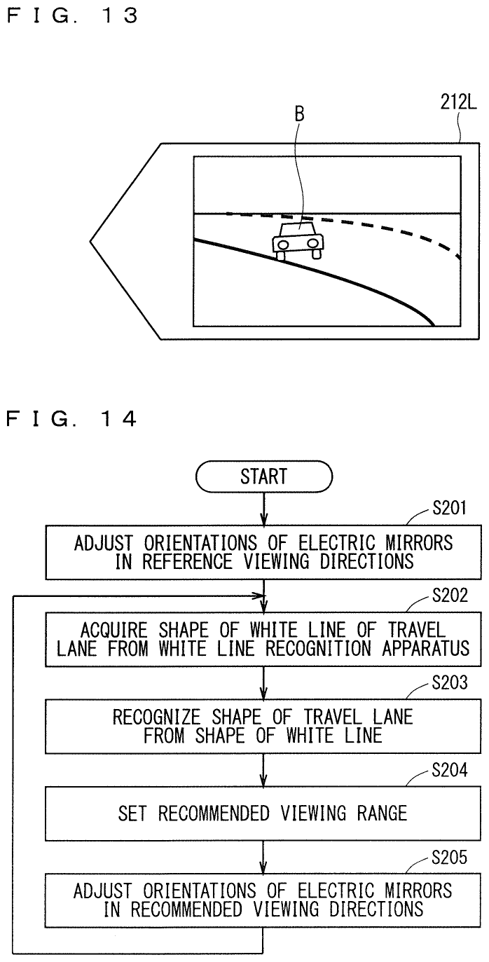

FIG. 14 is a flowchart showing operation of the lateral rear image display system in Embodiment 2. The operation of the lateral rear image display system in Embodiment 2 will be described below with reference to FIG. 14. This flow starts at a timing of powering on of accessories of the subject vehicle A, and continues until the accessories of the subject vehicle A are powered off, for example.

First, upon controlled by the mirror controller 13A, the mirror driving unit 211 adjusts the orientations of the electric mirrors 212L and 212R in the reference viewing directions so that the electric mirrors 212L and 212R display images in the reference viewing ranges 50L and 50R to the driver (step S201).

Next, the lane shape acquisition unit 11 acquires the white line recognition information from the white line recognition apparatus 31, and recognizes the shape of the travel lane of the subject vehicle A based on the white line recognition information (step S202).

Then, the viewing range setting unit 12 acquires the information on the shape of the travel lane behind the subject vehicle A from the lane shape acquisition unit 11, and sets the recommended viewing range based on the acquired information (step S203). The recommended viewing range is set as described with reference to FIG. 12.

Finally, upon controlled by the mirror controller 13A, the mirror driving unit 211 adjusts the orientations of the electric mirrors 212L and 212R in recommended viewing directions so that the electric mirrors 212L and 212R display images in the recommended viewing ranges 52L and 52R to the driver (step S204). The flow then returns to the step S202.

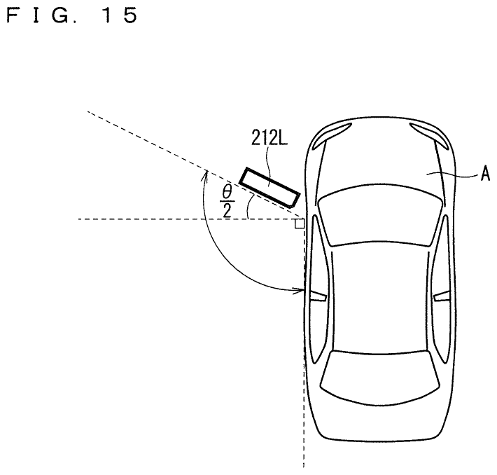

FIG. 15 illustrates an example of adjustment of the orientation of the electric mirror 212L. An angle formed by a mirror surface as a display surface of the electric mirror 212L and a line extending along a left side surface of the body of the subject vehicle A is herein referred to as a mirror angle. The mirror angle when the electric mirror 212L displays the image in the reference viewing range to the driver, that is to say, when the electric mirror 212L is oriented in the reference viewing direction is 90°. When an angle formed by a line extending from the subject vehicle A to the first recommended viewing point Q1 and the line extending along the left side surface of the body of the subject vehicle A is set to 0 as illustrated in FIG. 12, the mirror driving unit 211 adjusts the mirror angle of the electric mirror 212L at 90°+0/2. This allows the driver to view the image in the recommended viewing range in the electric mirror 212L. Although the example of adjustment of the orientation of the electric mirror 212L is illustrated in FIG. 15, the same applies to adjustment of the orientation of the electric mirror 212R.

Description is made above on the viewing range setting unit 12 setting the recommended viewing range based on the horizontal shape of the travel lane. The viewing range setting unit 12, however, may set the recommended viewing range based on the vertical shape, that is to say, the grade of the travel lane or based on both the horizontal shape and the vertical shape. A method of setting the recommended viewing range based on the grade of the travel lane will be described below. The grade of the travel lane can be acquired from the white line recognition information acquired from the white line recognition apparatus 31 by the lane shape acquisition unit 11.

FIG. 16 illustrates a state of the subject vehicle A traveling on a flat land at t=T1 and then traveling on an uphill road at t=T2. Assume that the travel lane is straight for ease of explanation. The viewing range setting unit 12 sets, to the recommended viewing range 52R, a range including the first recommended viewing point Q1 located 30 m back away from the head location of the subject vehicle A along the travel lane and the second recommended viewing point Q2 located 5 m away from the first recommended viewing point Q1 to the right relative to the direction of travel in the travel lane. The recommended viewing range 52R thus includes the recommended viewing points Q1 and Q2 at t=T1.

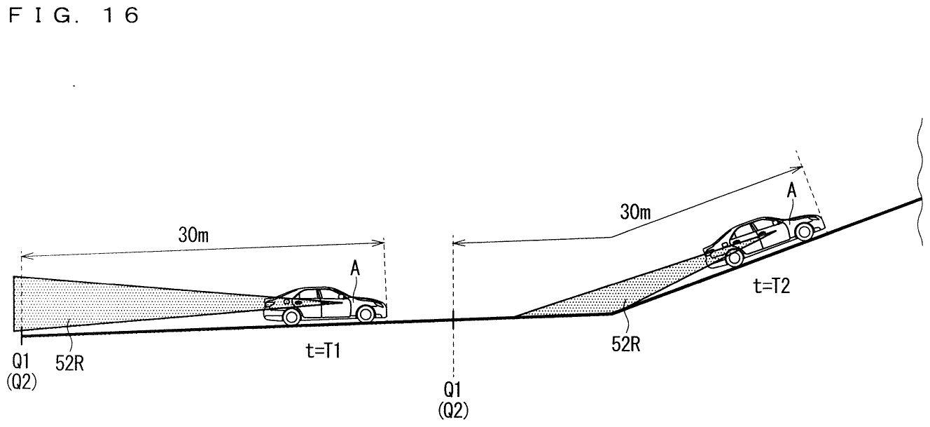

At t=T2, however, the recommended viewing range 52R does not include the recommended viewing points Q1 and Q2 if it is the same as that at t=T1 because the subject vehicle travels in the travel lane having an upgrade. The recommended viewing range 52R is thus moved upwards to include the recommended viewing points Q1 and Q2 at t=T2 as illustrated in FIG. 17. The recommended viewing points Q1 and Q2 can thereby be displayed on the electric mirror 212R at t=T2.

Although the recommended viewing range 52R at the right rear of the subject vehicle A is described with reference to FIGS. 16 and 17, the same applies to the recommended viewing range 52L at the left rear of the subject vehicle A. While the recommended viewing ranges 52L and 52R are moved upwards in the travel lane having the upgrade, the recommended viewing ranges 52L and 52R are moved downwards in the travel lane having a downgrade. As described above, the viewing range setting unit 12 moves the recommended viewing ranges 52L and 52R upwards or downwards in accordance with the grade of the travel lane of the subject vehicle A to thereby set appropriate recommended viewing ranges in accordance with the grade of the travel lane.

A case where only the grade of the lane is considered is described with reference to FIGS. 16 and 17 for ease of explanation. The recommended viewing ranges, however, may be set in consideration of both the horizontal shape and the grade of the lane. This allows the driver to view images in the appropriate recommended viewing ranges in accordance with a road having a three-dimensional shape changed rapidly, such as an interchange, a highway entrance or exit, and a junction.

### Modification of Embodiment 2

As illustrated in FIG. 13, the electric mirrors 212L and 212R each have a single mirror surface, and display the image in the recommended viewing range in the mirror surface. Since the recommended viewing range coincides with the reference viewing range when the subject vehicle A travels in a straight lane, it can be said that the image in the reference viewing range is displayed in the mirror surface of each of the electric mirrors 212L and 212R when the subject vehicle A travels in the straight lane.

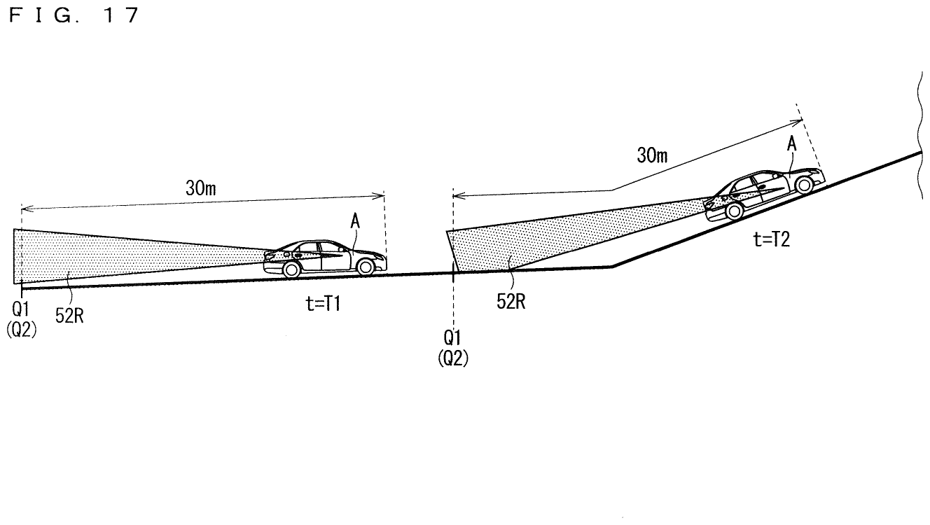

In a modification of the present embodiment, the electric mirror may have two mirror surfaces whose mirror angles are adjustable independently of each other. FIG. 18 illustrates an electric mirror 213L in the modification. The electric mirror 213L has a first mirror surface 441 and a second mirror surface 442. The image in the recommended viewing range is displayed in the first mirror surface 441, and the image in the reference viewing range is displayed in the second mirror surface 442. The driver can thereby view the image in the recommended viewing range and the image in the reference viewing range at the same time.

### Effects of Embodiment 2

In Embodiment 2, the information on the shape of the travel lane includes the information on the curvature of the travel lane. According to the lateral rear image control apparatus 102, the recommended viewing range is set based on the curvature of the travel lane, so that the driver can view the image in the appropriate recommended viewing range in accordance with the curvature of the travel lane.

In Embodiment 2, the information on the shape of the travel lane includes the information on the grade of the travel lane. According to the lateral rear image control apparatus 102, the recommended viewing range is set based on the grade of the travel lane, so that the driver can view the image in the appropriate recommended viewing range in accordance with the grade of the travel lane.

The recommended viewing range includes the first recommended viewing point located the first distance behind the subject vehicle along the travel lane and the second recommended viewing point located the second distance away from the first recommended viewing point in the direction normal to the direction of travel of the subject vehicle. According to the lateral rear image control apparatus 102, the driver can view the non-subject vehicle traveling behind the subject vehicle.

In Embodiment 2, the lateral rear image display apparatus 22 includes the electric mirrors 212L and 212R of the subject vehicle A, and the mirror controller 13A of the lateral rear image display apparatus 22 controls the orientations of the electric mirrors 212L and 212R. According to the lateral rear image display apparatus 22, the driver can view the images in the recommended viewing ranges in the electric mirrors 212L and 212R.

In Embodiment 2, the lane shape acquisition unit 11 acquires the information on the shape of the travel lane based on a result of recognition of the white line recognition apparatus 31 recognizing the white line of the travel lane. According to the lateral rear image display apparatus 22 in Embodiment 2, the recommended viewing range can be set while the shape of the lane is accurately grasped.

The viewing range setting unit 12 sets, regardless of the information on the shape of the travel lane behind the subject vehicle A, regions located in particular directions relative to the subject vehicle A at the lateral rear of the subject vehicle A to the reference viewing ranges 50L and 50R. In the modification of Embodiment 2, the mirror controller 13A controls the mirror driving unit 211 of the lateral rear image display apparatus 22 so that the image in the recommended viewing range and the image in the reference viewing range are displayed to the driver as illustrated in FIG. 18. The driver can thus view the image in the recommended viewing range and the image in the reference viewing range at the same time in the mirror.

### Embodiment 3

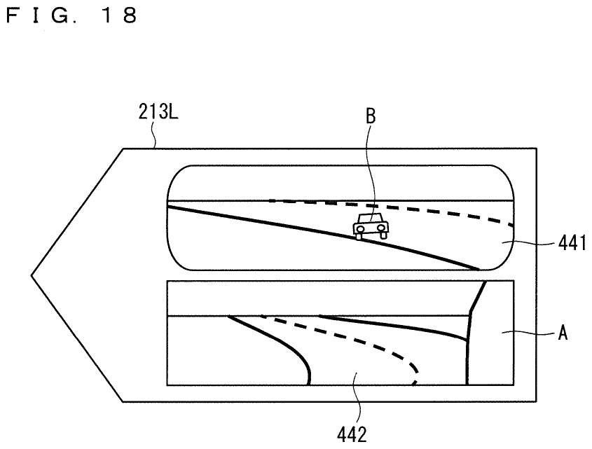

FIG. 19 is a block diagram showing a configuration of a lateral rear image display system in Embodiment 3. In FIG. 19, components being the same as or corresponding to components in the other embodiments bear the same reference signs as those of the same or corresponding components. The lateral rear image display system in Embodiment 3 includes, as the lateral rear image display apparatus, electronic mirrors in place of the electric mirrors in the lateral rear image display system in Embodiment 2.

The lateral rear image display system in Embodiment 3 includes a lateral rear image control apparatus 103, a lateral rear image display apparatus 23, and the white line recognition apparatus 31. The lateral rear image control apparatus 103 includes a camera controller 13B in place of the mirror controller 13A in the configuration of the lateral rear image control apparatus 102 in Embodiment 2.

The camera controller 13B controls a camera driving unit 231 so that each of cameras 232L and 232R captures an image in the recommended viewing range. In the present embodiment, a direction when each of the cameras 232L and 232R captures the image in the recommended viewing range is referred to as a recommended viewing direction, and a direction when each of the cameras 232L and 232R captures an image in the reference viewing range is referred to as a reference viewing direction.

The lateral rear image display apparatus 23 includes the camera driving unit 231, the cameras 232L and 232R, and monitors 233L and 233R. The camera 232L is mounted on the front side of the left door of the subject vehicle A, for example, and captures an image at the left rear of the subject vehicle A. The camera 232R is mounted on the front side of the right door of the subject vehicle A, for example, and captures an image at the right rear of the subject vehicle A. The camera driving unit 231 adjusts image capturing directions of the cameras 232L and 232R in the recommended viewing directions in accordance with control of the camera controller 13B.

The image captured by the camera 232L is displayed on the monitor 233L, and the image captured by the camera 232R is displayed on the monitor 233R. The monitors 233L and 233R are mounted on the subject vehicle A, and are viewed by the driver. The driver can thus view the images in the recommended viewing ranges on the monitors 233L and 233R.

### Effects of Embodiment 3

In Embodiment 3, the lateral rear image display apparatus 23 includes the cameras 232L and 233R as image capturing devices capturing images at the lateral rear of the subject vehicle A and the monitors 233L and 233R mounted on the subject vehicle A to display the images captured by the cameras 232L and 233R. The driver can thus view the images in the recommended viewing ranges on the monitors 233L and 233R.

Furthermore, in the lateral rear image control apparatus 103 in Embodiment 3, the camera controller 13B controls the image capturing directions of the cameras 232L and 232R. The driver can thus view the images in the recommended viewing ranges on the monitors 233L and 233R.

### Embodiment 4

In Embodiment 3, the camera driving unit 231 adjusts the image capturing directions of the cameras 232L and 232R in the recommended viewing directions, so that the images in the recommended viewing ranges are displayed on the monitors 233L and 233R. In contrast, in Embodiment 4, after images being in wider ranges than the recommended viewing ranges and including the images in the recommended viewing ranges are captured using wide-angle cameras, the images captured by the wide-angle cameras are cropped to be the images in the recommended viewing ranges, and the images in the recommended viewing ranges are displayed on the monitors 233L and 233R.

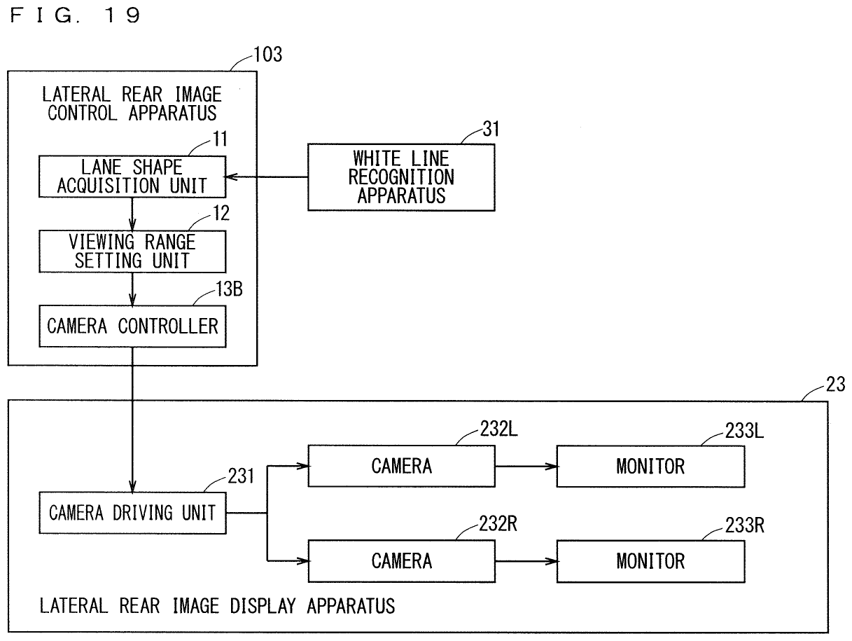

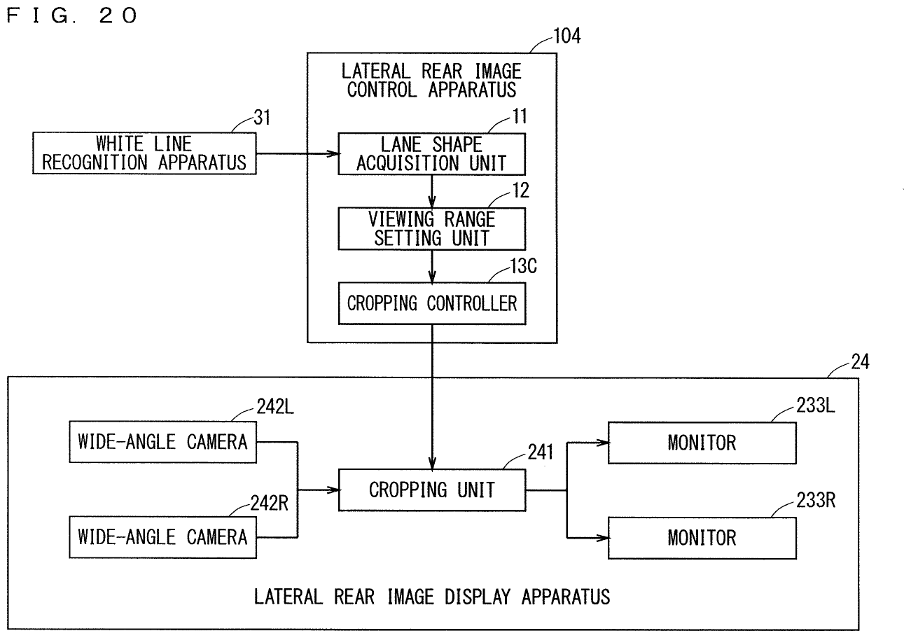

FIG. 20 is a block diagram showing a configuration of a lateral rear image display system in Embodiment 4. In FIG. 20, components being the same as or corresponding to components in the other embodiments bear the same reference signs as those of the same or corresponding components. The lateral rear image display system in Embodiment 4 includes a lateral rear image control apparatus 104, a lateral rear image display apparatus 24, and the white line recognition apparatus 31. The lateral rear image control apparatus 104 includes a cropping controller 13C in place of the camera controller 13B in the configuration of the lateral rear image control apparatus 103 in Embodiment 3.

The cropping controller 13C controls cropping of images captured by wide-angle cameras 242L and 242R performed by a cropping unit 241.

The lateral rear image display apparatus 24 includes the wide-angle cameras 242L and 242R, the cropping unit 241, and the monitors 233L and 233R. The wide-angle camera 242L is mounted on the front side of the left door of the subject vehicle A, for example, and captures an image at the left rear of the subject vehicle A. The wide-angle camera 242R is mounted on the front side of the right door of the subject vehicle A, for example, and captures an image at the right rear of the subject vehicle A.

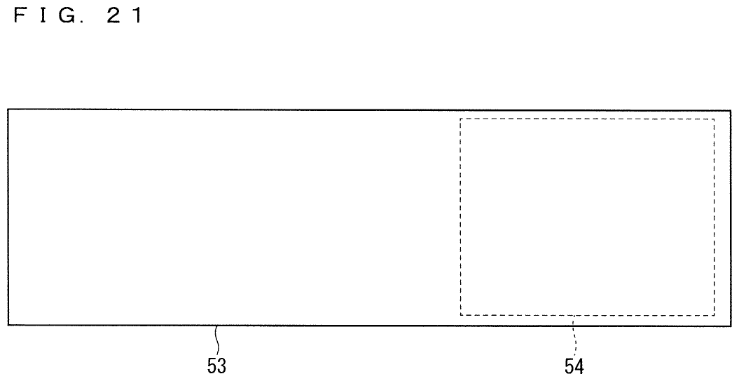

The cropping unit 241 crops the images captured by the wide-angle cameras 242L and 242R. As illustrated in FIG. 21, a part of a range of an image 53 captured by each of the wide-angle cameras 242L and 242R is a cropping range 54. An image acquired through cropping of the image captured by the wide-angle camera 242L is displayed on the monitor 233L, and an image acquired through cropping of the image captured by the wide-angle camera 242R is displayed on the monitor 233R.

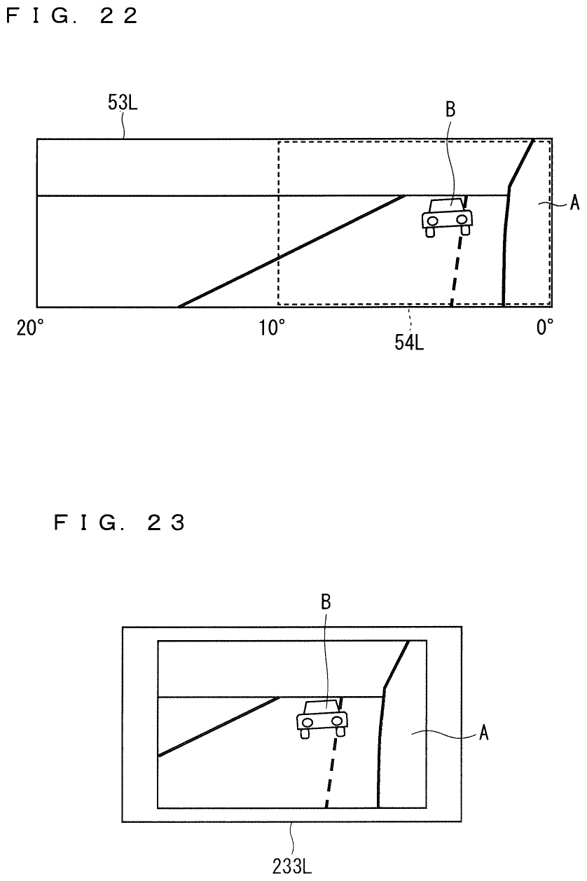

FIG. 22 illustrates a relationship between an image 53L captured by the wide-angle camera 242L when the subject vehicle A travels in the straight lane and the cropping range. An image capturing direction when the image 53L is captured is added below the image 53L in FIG. 22. The wide-angle camera 242L has an angle of view of 20°, and an image capturing direction is set at 0° at the right end of the image 53L and at 20° at the left end of the image 53L. When the subject vehicle A travels in the straight lane, the driver is required to view the image in the reference viewing range. The cropping unit 241 thus sets a range of the image 53L corresponding to the reference viewing range to a cropping range 54L. In the example of FIG. 22, a range of the image 53L in which the image capturing direction is at 0° to 10° is the cropping range 54L. The image in the reference viewing range including the non-subject vehicle B is thus displayed on the monitor 233L as illustrated in FIG. 23.

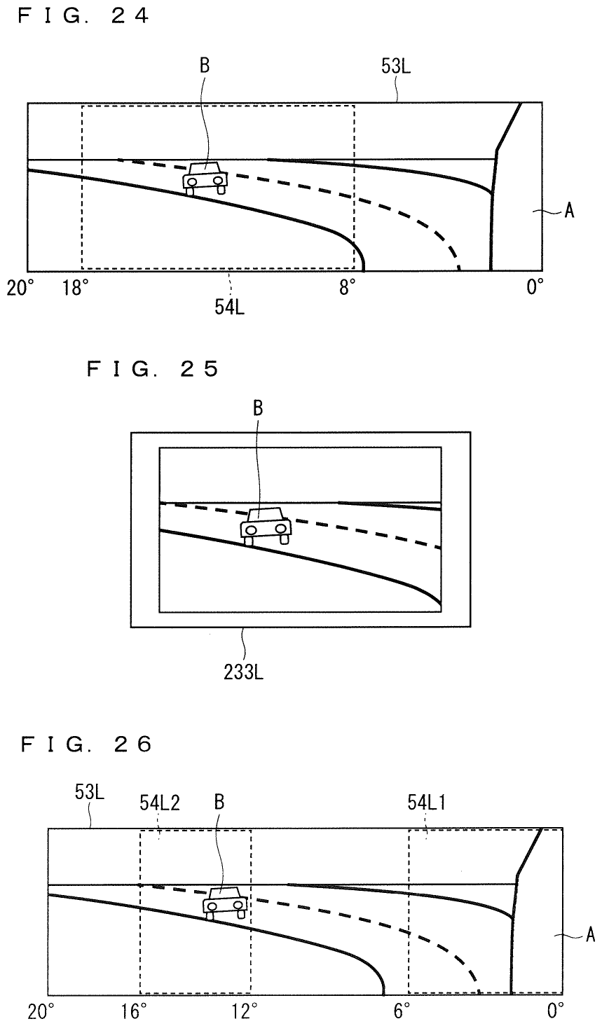

FIG. 24 illustrates a relationship between the image 53L captured by the wide-angle camera 242L when the subject vehicle A travels in the curved lane and the cropping range. When the subject vehicle A travels in the curved lane, the driver is required to view the image in the recommended viewing range. The cropping unit 241 thus sets a range of the image 53L corresponding to the recommended viewing range to the cropping range 54L. In the example of FIG. 24, a range of the image 53L in which the image capturing direction is at 8° to 18° is the cropping range 54L. The image in the recommended viewing direction including the non-subject vehicle B is thus displayed on the monitor 233L as illustrated in FIG. 25.

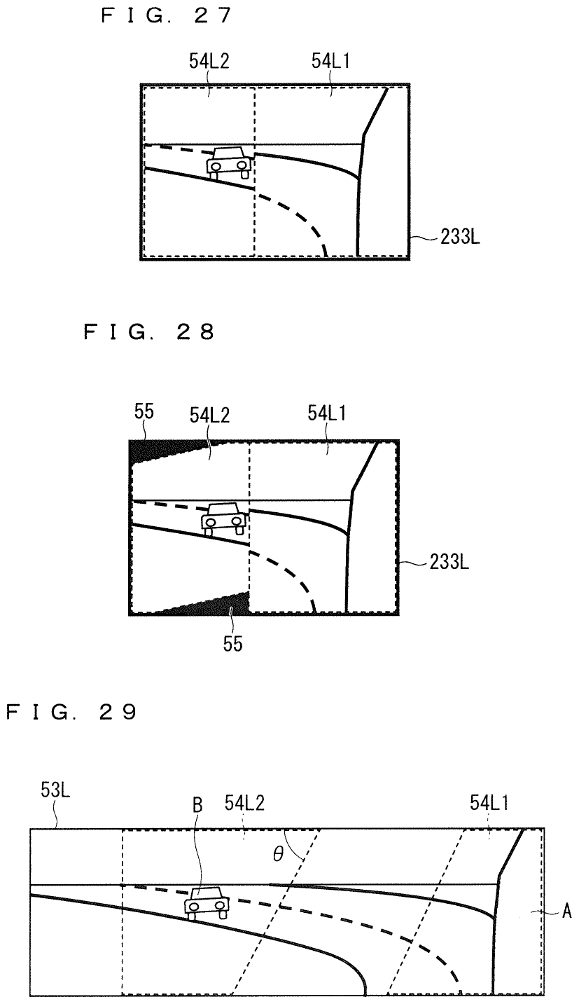

Alternatively, when the subject vehicle A travels in the curved lane, both the image in the recommended viewing range and the image in the reference viewing range may be acquired through cropping as illustrated in FIG. 26. In this example, the cropping unit 241 crops the image 53L so that an image in a range 54L1 in which the image capturing direction is at 0° to 6° is acquired as the image in the reference viewing range and an image in a range 54L2 in which the image capturing direction is at 12° to 16° is acquired as the image in the recommended viewing range. A total angle of view of the two images thus acquired through cropping is 10°, and is equal to a display range of the monitor 233L. The image in the recommended viewing range and the image in the reference viewing range can thus be displayed side by side on the monitor 233L without changing the size of a screen of the monitor 233L as illustrated in FIG. 27.

In this case, an inclined image 55 showing an image capturing direction of the image 53L in the image 54L2 in the recommended viewing range may be added to the image 54L2 as illustrated in FIG. 28. The driver can thereby easily recognize a difference between the image in the recommended viewing range and the image in the reference viewing range.

The cropping range may not be rectangular, and may be trapezoidal, for example, as illustrated in FIG. 29. That is to say, the cropping unit 241 acquires a trapezoidal image in the recommended viewing range through cropping. In this case, images in appropriate recommended viewing ranges are displayed on the monitors 233L and 233R in accordance with the shape of the travel lane by adjusting an angle θ of the trapezoid in accordance with curvature of the travel lane in the recommended viewing ranges. The shape of the cropping range is not limited to a trapezoid as a quadrilateral, and a curved line or a plurality of line segments may be used as a part of the cropping range to form a shape similar to the trapezoid. For example, a left side of the cropping range 54L1 may be convex, and a right side of the cropping range 54L2 may be concave.

### Effects of Embodiment 4

The lateral rear image display apparatus 24 in Embodiment 4 includes the cropping unit 241 cropping the images captured by the wide-angle cameras 242L and 242R as the image capturing devices, and the monitors 233L and 233R display the images acquired through cropping of the cropping unit 241. The cropping controller 13C of the lateral rear image control apparatus 104 in Embodiment 4 controls the cropping ranges of the cropping unit 241. The cropping ranges are adjusted to the recommended viewing ranges, so that the driver can view the images in the recommended viewing ranges on the monitors 233L and 233R.

In Embodiments 3 and 4, the lateral rear image control apparatuses 103 and 104 each acquire the shape of the lane using the white line recognition apparatus 31. In each of the lateral rear image control apparatuses 103 and 104, however, the lane shape acquisition unit 11 may acquire the images captured by the left and right cameras, and perform image recognition to recognize the white line to thereby acquire the shape of the lane. According to such a configuration, the white line recognition apparatus 31 can be omitted to reduce cost.

In Embodiment 4, the lateral rear image display apparatus 24 performs cropping, but the lateral rear image control apparatus 104 may perform cropping. In this case, the cropping unit 241 is included not in the lateral rear image control apparatus 24 but in the lateral rear image control apparatus 104.

The wide-angle camera 242L is described above to have the angle of view of 20°, but the angle of view of each of the wide-angle cameras 242L and 242R is not limited to 20°. Various angles of view are used in accordance with the specifications of the wide-angle cameras 242L and 242R.

### Embodiment 5

In Embodiment 5, an image to be cropped by the cropping unit 241 in Embodiment 4 is an image acquired by combining images captured by a plurality of cameras having different image capturing directions.

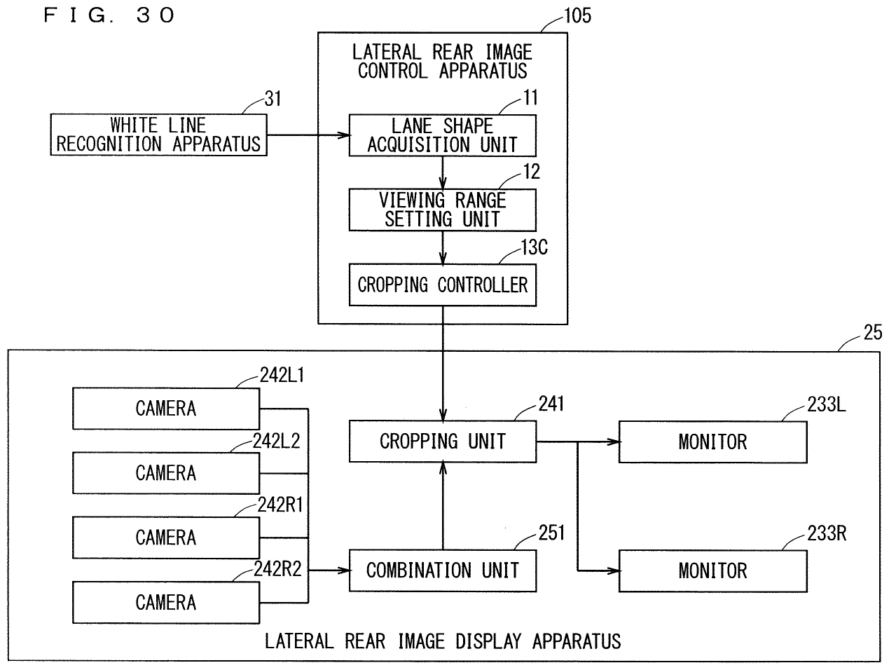

FIG. 30 is a block diagram showing a configuration of a lateral rear image control system in Embodiment 5. The lateral rear image control system in Embodiment 5 includes a lateral rear image control apparatus 105, a lateral rear image display apparatus 25, and the white line recognition apparatus 31. In FIG. 30, components being the same as or corresponding to components in the other embodiments bear the same reference signs as those of the same or corresponding components.

The lateral rear image control apparatus 105 is similar to the lateral rear image control apparatus 104 in Embodiment 4. The lateral rear image display apparatus 25 includes cameras 242L1 and 242L2 in place of the wide-angle camera 242L, includes cameras 242R1 and 242R2 in place of the wide-angle camera 242R, and further includes a combination unit 251 in the configuration of the lateral rear image display apparatus 24 in Embodiment 4.

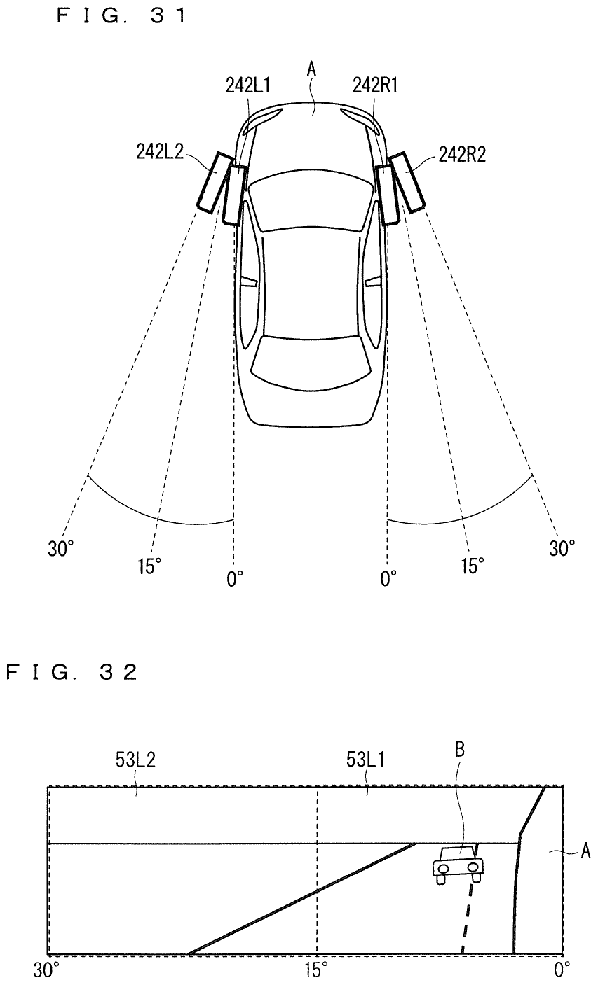

FIG. 31 illustrates installation locations of the cameras 242L1, 242L2, 242R1, and 242R2 in the subject vehicle A. The cameras 242L1 and 242L2 are installed in a left front side of the subject vehicle A. When the left side surface of the subject vehicle A is in a direction at 0°, the camera 242L1 captures an image in a direction at 0° to 15°. Similarly, the camera 242L2 captures an image in a direction at 15° to 30°. The cameras 242R1 and 242R2 are installed in a right front side of the subject vehicle A. When the left side surface of the subject vehicle A is in a direction at 0°, the camera 242R1 captures an image in a direction at 0° to 15°. Similarly, the camera 242L2 captures an image in a direction at 15° to 30°.

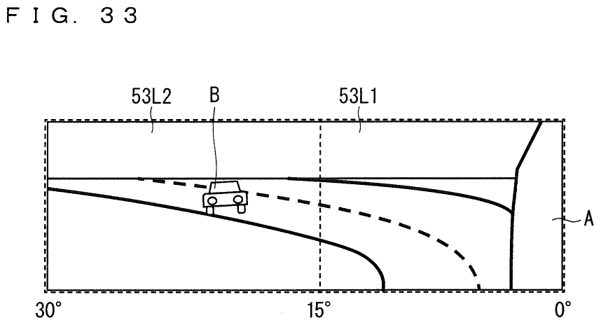

FIGS. 32 and 33 illustrate combined images acquired by the combination unit 251. FIG. 32 illustrates a combined image when the subject vehicle A travels in the straight lane, and FIG. 33 illustrates a combined image when the subject vehicle A travels in the curved lane. The combination unit 251 combines an image 53L2 captured by the camera 242L2 and an image 53L1 captured by the camera 242L1 so that the image 53L2 is located on a left side and the image 53L1 is located on a right side as in an actual image capturing direction. In each of FIGS. 32 and 33, the image capturing directions of the cameras are attached below the combined image. While the image acquired by combining the images captured by the cameras 242L1 and 242L2 is illustrated in each of FIGS. 32 and 33, the images captured by the cameras 242R1 and 242R2 are combined in a similar manner.

The cropping unit 241 crops the combined image created by the combination unit 251 to acquire a region showing the recommended viewing range as in Embodiment 4. That is to say, the cropping unit 241 crops the image acquired by combining the images captured by the cameras 242L1 and 242L2, and crops the image acquired by combining the images captured by the cameras 242R1 and 242R2.

The monitor 233L displays an image acquired through cropping of the image acquired by combining the images captured by the cameras 242L1 and 242L2. The monitor 233R displays an image acquired through cropping of the image acquired by combining the images captured by the cameras 242R1 and 242R2. The driver can thereby view the image in the recommended viewing range at the left rear of the subject vehicle A on the monitor 233L, and view the image in the recommended viewing range at the right rear of the subject vehicle A on the monitor 233R.

### Effects of Embodiment 5

In Embodiment 5, the image capturing devices of the lateral rear image display apparatus 25 are a plurality of cameras having different image capturing directions, that is to say, the cameras 242L1, 242L2, 242R1, and 242R2. The lateral rear image display apparatus 25 includes the combination unit 251 combining the images captured by the cameras 242L1, 242L2, 242R1, and 242R2. The cropping unit 241 crops the combined image acquired by the combination unit 251. According to the configuration in Embodiment 5, the driver can view the images in the recommended viewing ranges changed in accordance with the shape of the lane without using the camera driving unit adjusting the image capturing directions of the cameras 242L1, 242L2, 242R1, and 242R2. Furthermore, cropping can be performed in accordance with the recommended viewing ranges without using the wide-angle cameras, so that the driver can view the images in the recommended viewing ranges on the monitors 233L and 233R.

### Embodiment 6

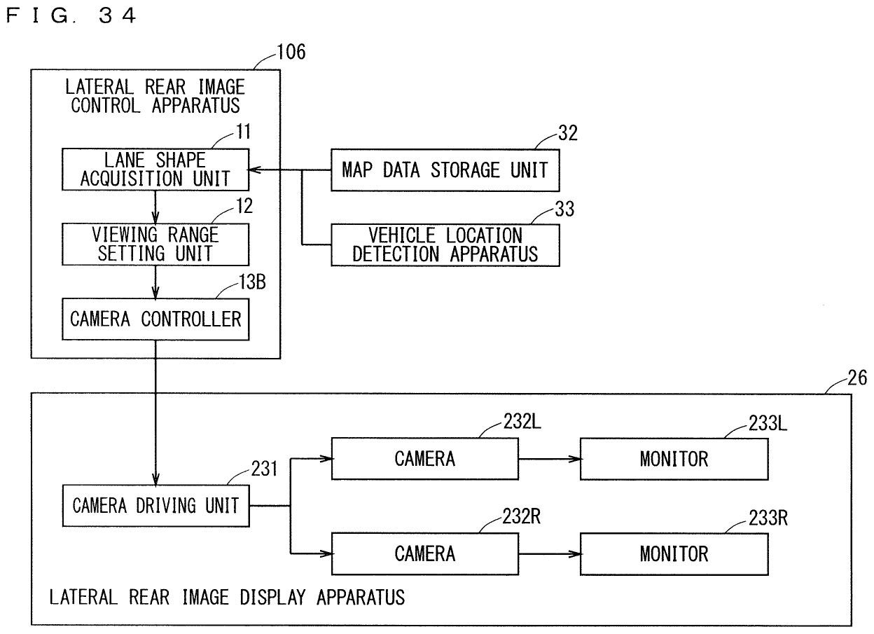

FIG. 34 is a block diagram showing a configuration of a lateral rear image display system in Embodiment 6. The lateral rear image display system in Embodiment 6 includes a lateral rear image control apparatus 106, a lateral rear image display apparatus 26, a map data storage unit 32, and a vehicle location detection apparatus 33.

The lateral rear image control apparatus 106 has a similar configuration to the lateral rear image control apparatus 103 in Embodiment 3, and the lateral rear image display apparatus 26 has a similar configuration to the lateral rear image display apparatus 23 in Embodiment 3.

In Embodiment 6, the lane shape acquisition unit 11 acquires the shape of the travel lane of the subject vehicle by a different method than that in Embodiment 3, and Embodiment 6 is similar to Embodiment 3 in the other respects.

The map data storage unit 32 stores map data. The map data includes information on the shape of each lane of a road.

The vehicle location detection apparatus 33 detects an absolute location of the subject vehicle A using a navigation satellite system (NSS), such as a global positioning system (GPS) and a quasi-zenith satellite system (QZSS), and a vehicle sensor, such as a vehicle speed sensor and an acceleration sensor, mounted on the subject vehicle A.

The lane shape acquisition unit 11 acquires the absolute location of the subject vehicle A from the vehicle location detection apparatus 33. The lane shape acquisition unit 11 acquires the shape of the travel lane of the subject vehicle A by referring to the map data stored in the map data storage unit 32 based on the absolute location of the subject vehicle A.

In the map data, the shape of the lane is expressed, for example, by an array of coordinates of nodes at opposite ends of a lane link and shape complementary points in the lane link.

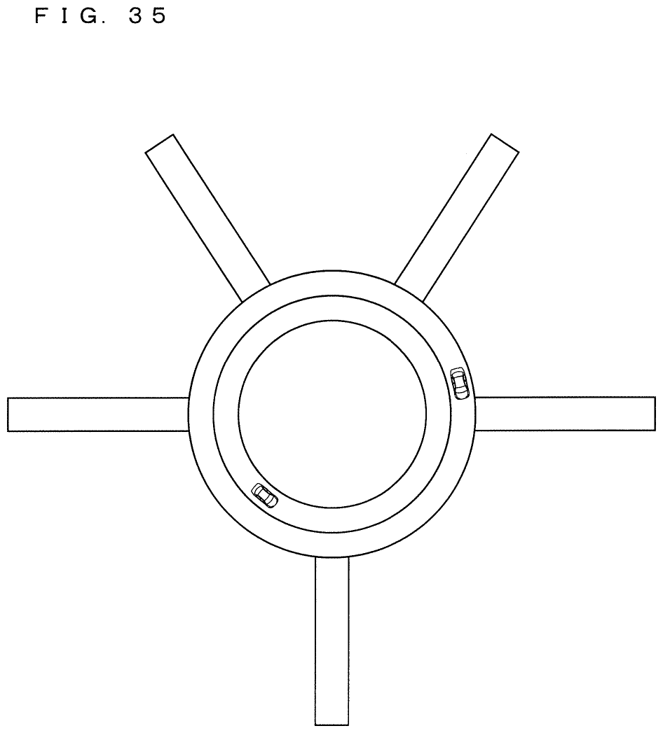

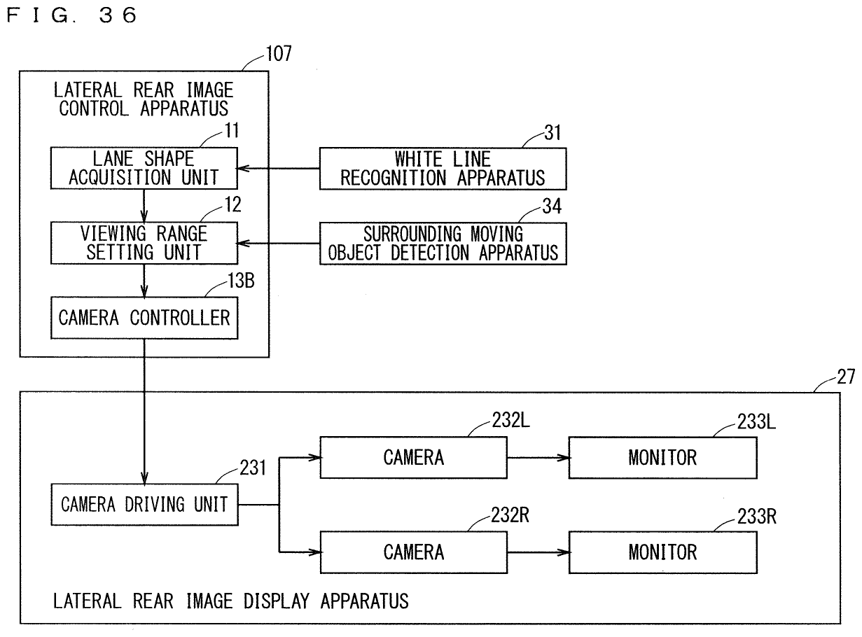

The shape of the lane may be expressed in any manner as long as the shape of a road in the map database is shown. For example, the lane link may be divided into sublinks each including lane sections continuously having the same curvature, and the shape of the lane may be expressed by a set of sublinks. Information on coordinates, curvature, and length is provided for each sublink. In this case, curvature is fixed in a single lane sublink, and thus the camera driving unit 231 is not required to change the orientations of the cameras 232L and 232R. Processing performed by the camera controller 13B and the camera driving unit 231 can thus be reduced. In particular, in a perfect circular roundabout illustrated in FIG. 35, curvature is always fixed, and the shape of the lane is expressed by a single lane sublink. The orientations of the cameras 232L and 232R can always be fixed during travel on the roundabout. That is to say, the processing performed by the camera controller 13B and the camera driving unit 231 can be reduced.

The map data storage unit 32 is stored, for example, in a data server external to the lateral rear image control apparatus 106. The map data storage unit 32 may alternatively be included in the lateral rear image control apparatus 106.

### Effects of Embodiment 6

In the lateral rear image control apparatus 106 in Embodiment 6, the lane shape acquisition unit 11 acquires the information on the shape of the travel lane by referring to the map data based on information on the location of the subject vehicle. The information on the shape of the travel lane can thus accurately be acquired. The lateral rear image control apparatus 106 can thus set the recommended viewing range with high accuracy.

A map data format in which lane sections continuously having the same curvature are expressed by a single sublink, and the shape of the lane is expressed as a set of sublinks may be used. In this case, curvature is fixed in a single sublink, and thus the viewing range setting unit 12 is not required to change the recommended viewing range. Control processing performed by the camera controller 13B and processing to drive the cameras performed by the camera driving unit 231 are thus not performed in the single sublink, and thus processing performed in this configuration can be reduced.

### Embodiment 7

In Embodiment 7, a region including the non-subject vehicle traveling in a lane adjacent to the travel lane of the subject vehicle A is set to the recommended viewing range.

FIG. 36 is a block diagram showing a configuration of a lateral rear image display system in Embodiment 7. The lateral rear image display system in Embodiment 7 includes a lateral rear image control apparatus 107, a lateral rear image display apparatus 27, the white line recognition apparatus 31, and a surrounding moving object detection apparatus 34. In FIG. 36, components being the same as or corresponding to components in the other embodiments bear the same reference signs as those of the same or corresponding components.

The lateral rear image control apparatus 107 has a similar configuration to the lateral rear image control apparatus 103 in Embodiment 3, and the lateral rear image display apparatus 27 has a similar configuration to the lateral rear image display apparatus 23 in Embodiment 3. That is to say, the lateral rear image display system in Embodiment 7 has the configuration of the lateral rear image display system in Embodiment 3 to which the surrounding moving object detection apparatus 34 has been added.

The surrounding moving object detection apparatus 34 is configured by a laser radar, a millimeter wave radar, an image processing sensor, an ultrasonic sensor, or other sensors, and detects the presence or absence of a moving object surrounding the subject vehicle A and the location or a change in location of the surrounding moving object relative to the subject vehicle A. Information detected by the surrounding moving object detection apparatus 34 is output to the viewing range setting unit 12 as surrounding moving object detection information.

Besides performing operation described in Embodiment 3, the viewing range setting unit 12 sets the recommended viewing range based on the surrounding moving object detection information.

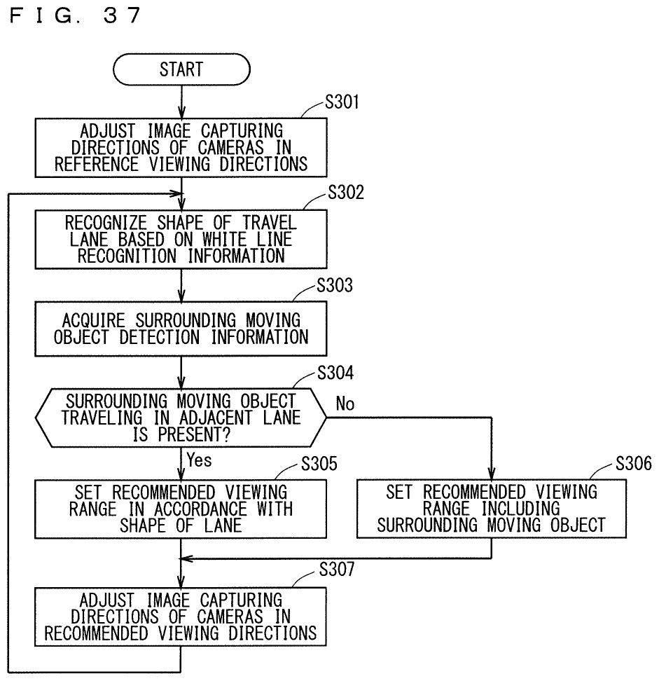

FIG. 37 is a flowchart showing operation of the lateral rear image display system in Embodiment 7. The operation of the lateral rear image display system in Embodiment 7 will be described below with reference to FIG. 37. This flow starts, for example, at the timing of powering on of the accessories of the subject vehicle A, and is repeated, for example, at fixed intervals during travel of the subject vehicle A.

Upon controlled by the camera controller 13B, the camera driving unit 231 adjusts the image capturing directions of the cameras 232L and 232R in the reference viewing directions (step S301).

Next, the lane shape acquisition unit 11 acquires the white line recognition information from the white line recognition apparatus 31, and recognizes the shape of the travel lane of the subject vehicle A based on the white line recognition information (step S302).

Then, the viewing range setting unit 12 acquires the surrounding moving object detection information from the surrounding moving object detection apparatus 34 (step S303).

Next, the viewing range setting unit 12 determines whether any other moving object (hereinafter, referred to as a “surrounding moving object”) traveling in a lane adjacent to the travel lane of the subject vehicle is present behind the subject vehicle based on the surrounding moving object detection information (step S304).

When the surrounding moving object is not present, the viewing range setting unit 12 sets the recommended viewing range in accordance with the shape of the travel lane (step S305). The recommended viewing range is set as described with reference to FIG. 12.

When the surrounding moving object is present, the viewing range setting unit 12 sets a region including the surrounding moving object to the recommended viewing range (step S306). When a plurality of surrounding moving objects are present, the viewing range setting unit 12 may set a region including one of the surrounding moving objects closest to the subject vehicle A to the recommended viewing range.

After the viewing range setting unit 12 sets the recommended viewing range in the step S305 or S306, processing performed by the lateral rear image display system transitions to step S307. In the step S307, upon controlled by the camera controller 13B, the camera driving unit 231 adjusts the image capturing directions of the cameras 232L and 232R in the recommended viewing directions (step S307). The flow then returns to the step S302.

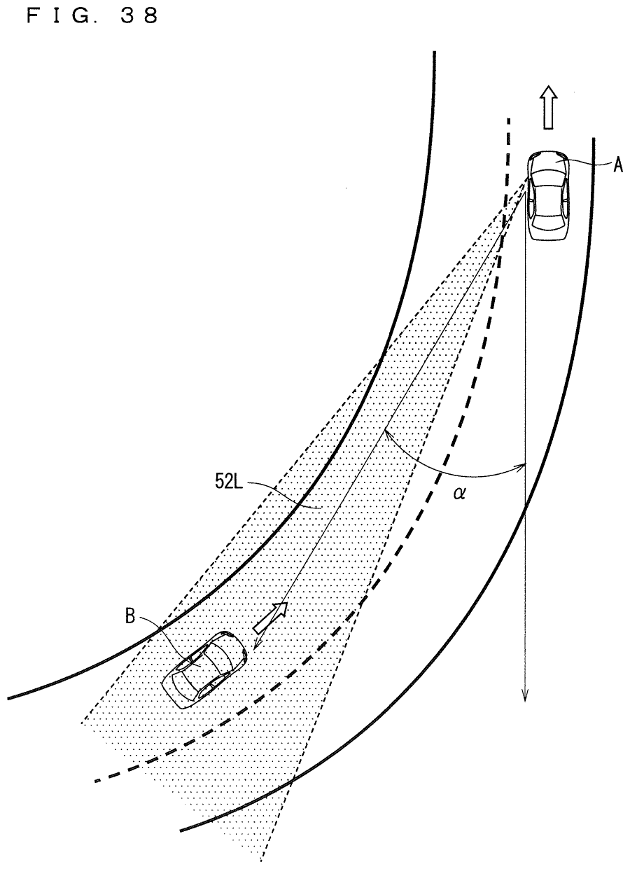

FIG. 38 illustrates the recommended viewing range in the present embodiment. In FIG. 38, the subject vehicle A travels in the right lane, and the non-subject vehicle B travels in the left lane behind the subject vehicle A. In this case, a region including the non-subject vehicle B is set to the recommended viewing range 52L at the left rear of the subject vehicle A. An angle formed by a straight line connecting the subject vehicle A and the non-subject vehicle B and the line extending along the left side surface of the body of the subject vehicle A is set to a.

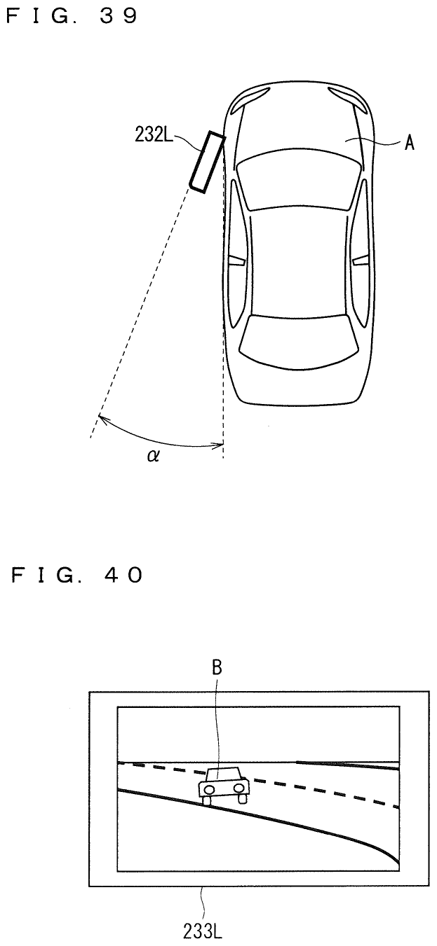

As illustrated in FIG. 39, the camera 232L is adjusted to be oriented in a direction the angle α away from the line extending along the left side surface of the body of the subject vehicle A. The camera 232L can thereby capture the image in the recommended viewing range 52L illustrated in FIG. 38. In this case, the image in the recommended viewing range 52L is displayed on the monitor 233L as illustrated in FIG. 40, so that the driver can view the non-subject vehicle B on the monitor 233L.

### Effects of Embodiment 7

The viewing range setting unit 12 of the lateral rear image control apparatus 107 in Embodiment 7 determines the presence or absence of the non-subject vehicle B as the moving object traveling in the lane adjacent to the travel lane of the subject vehicle A behind the subject vehicle A, and, when the non-subject vehicle B is present, sets the region including the non-subject vehicle B to the recommended viewing range. The driver can thus view the non-subject vehicle B on the monitors 233L and 233R.

### Embodiment 8

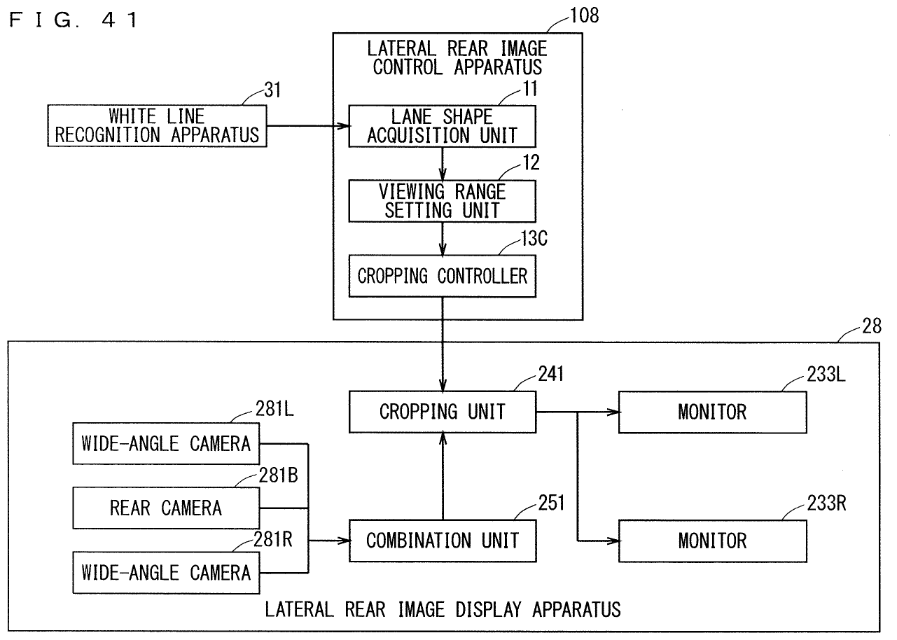

FIG. 41 is a block diagram showing a configuration of a lateral rear image display system in Embodiment 8. In FIG. 41, components being the same as or corresponding to components in the other embodiments bear the same reference signs as those of the same or corresponding components. The lateral rear image display system in Embodiment 8 includes a lateral rear image control apparatus 108, a lateral rear image display apparatus 28, and the white line recognition apparatus 31. The lateral rear image control apparatus 108 is similar to the lateral rear image control apparatus 104 in Embodiment 4.

The lateral rear image display apparatus 28 includes wide-angle cameras 281R and 281L and a rear camera 281B as the image capturing devices. The lateral rear image display apparatus 28 further includes the combination unit 251, the cropping unit 241, and the monitors 233L and 233R.

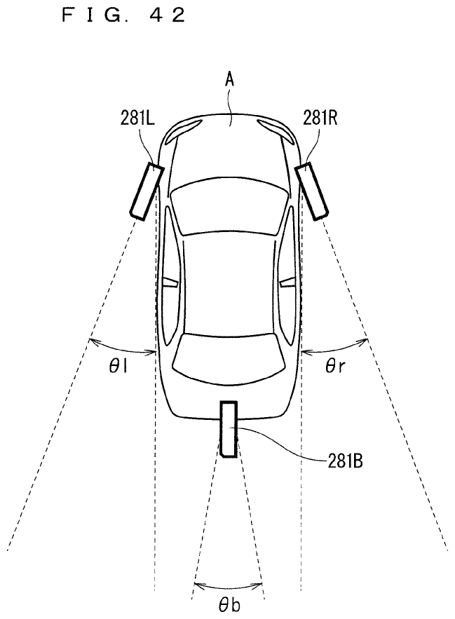

FIG. 42 illustrates installation locations of the cameras in the subject vehicle A. The wide-angle camera 281L is installed in the left front side of the subject vehicle A, and captures an image in a range of an angle θl from the left side surface of the subject vehicle A. The wide-angle camera 281R is installed in the right front side of the subject vehicle A, and captures an image in a range of an angle θr from the right side surface of the subject vehicle A. The rear camera 281B is installed in a rear side of the subject vehicle, and captures an image in a range of an angle θb around the rear side of the subject vehicle. For example, equations θl=θr=20° and θb=10° hold true.

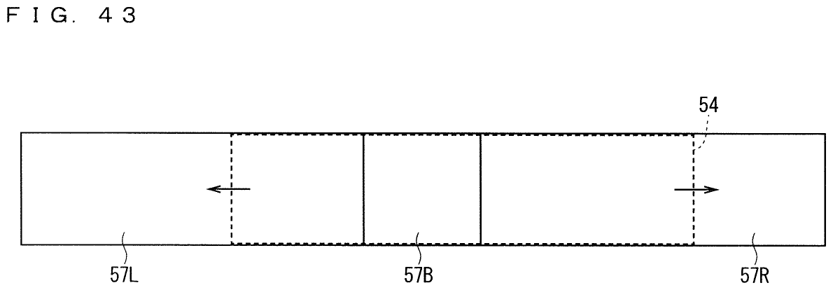

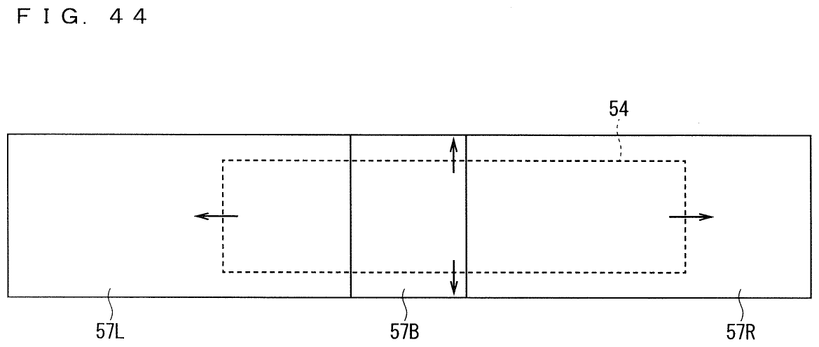

The combination unit 251 combines an image 57L captured by the wide-angle camera 281L, an image 57B captured by the rear camera 281B, and an image 57R captured by the wide-angle camera 281R to create a panoramic image. FIG. 43 illustrates the panoramic image. The images 57L, 57B, and 57R are respectively placed on a left side, in the middle, and on a right side of the panoramic image.

The cropping unit 241 adjusts the cropping range 54 of the panoramic image in accordance with the shape of the travel lane behind the subject vehicle A. The dimensions of the cropping range, however, are adjusted to the dimensions of display screens of the monitors 233L and 233R. Specifically, cropping is performed so that the images 57L and 57R are equally included when the subject vehicle A travels in the straight lane. When the subject vehicle A travels in a lane curved to the right, the cropping unit 241 moves the cropping range 54 to the right so that an image acquired through cropping of the image 57R is larger than an image acquired through cropping of the image 57L. When the subject vehicle travels in a lane curved to the left, the cropping unit 241 moves the cropping range 54 to the left so that the image acquired through cropping of the image 57L is larger than the image acquired through cropping of the image 57R. As described above, the cropping unit 241 crops the panoramic image in accordance with the recommended viewing range set in accordance with the shape of the travel lane.

In a case where the recommended viewing range is set only in consideration of the horizontal shape of the travel lane, such as curvature, the cropping range 54 is moved only horizontally with respect to the panoramic image as illustrated in FIG. 43. In a case where the recommended viewing range is set further in consideration of the grade of the travel lane, the cropping unit 241 moves a cropping frame not only horizontally but also vertically with respect to the panoramic image to perform cropping in accordance with the recommended viewing range.

### Effects of Embodiment 8

In Embodiment 8, the image capturing devices of the lateral rear image display apparatus 28 are a plurality of cameras having different image capturing directions, that is to say, the wide-angle cameras 281L and 281R and the rear camera 281B. The lateral rear image display apparatus 28 includes the combination unit 251 combining the images captured by the wide-angle cameras 281L and 281R and the rear camera 281B, and the cropping unit 241 crops the combined image acquired by the combination unit 251. The driver can thus view the image in the appropriate recommended viewing range in accordance with the shape of the travel lane.

### Embodiment 9

In Embodiment 9, a recommended viewing region is set appropriately when the subject vehicle makes a turn at an intersection.

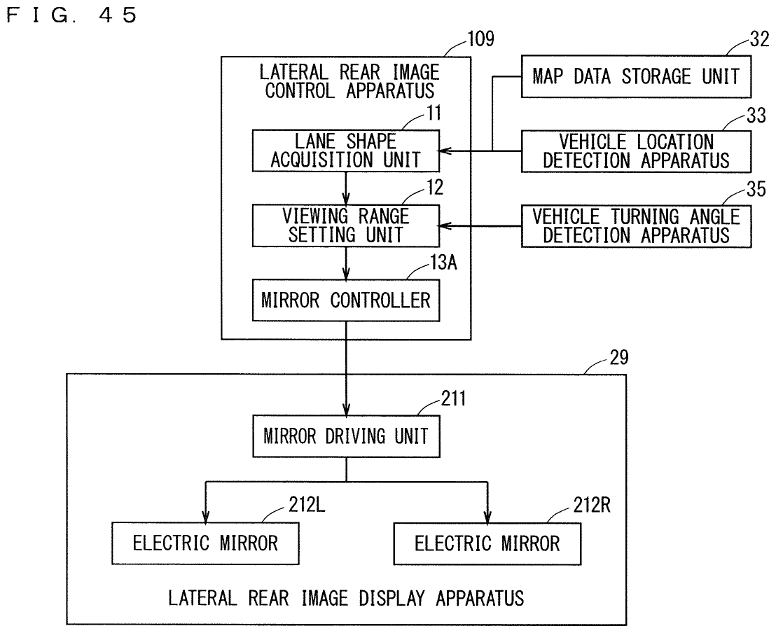

FIG. 45 is a block diagram showing a configuration of a lateral rear image control system in Embodiment 9. In FIG. 45, components being the same as or corresponding to components in the other embodiments bear the same reference signs as those of the same or corresponding components. The lateral rear image control system in Embodiment 9 includes a lateral rear image control apparatus 109, a lateral rear image display apparatus 29, the map data storage unit 32, the vehicle location detection apparatus 33, and a vehicle turning angle detection apparatus 35.

The lateral rear image control apparatus 109 and the lateral rear image display apparatus 29 respectively have similar configurations to the lateral rear image control apparatus 102 and the lateral rear image display apparatus 22 in Embodiment 2.

The lateral rear image control apparatus 109, however, is connected to the map data storage unit 32, the vehicle location detection apparatus 33, and the vehicle turning angle detection apparatus 35, and is configured to be able to use them.

The vehicle turning angle detection apparatus 35 detects a turning angle while the subject vehicle makes a right or left turn, and outputs the detected turning angle to the viewing range setting unit 12.

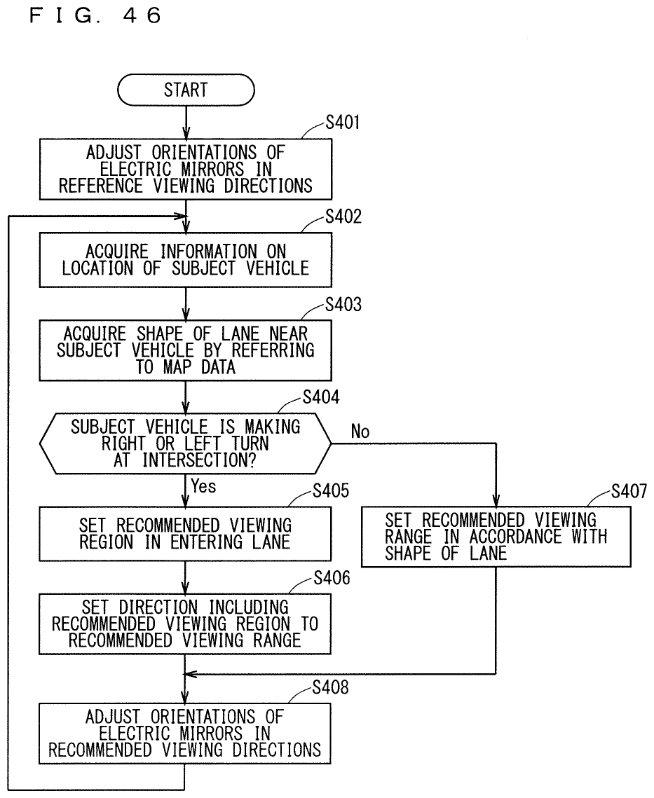

FIG. 46 is a flowchart showing operation of the lateral rear image control system in Embodiment 9. The operation of the lateral rear image control system in Embodiment 9 will be described below with reference to FIG. 46.

First, upon controlled by the mirror controller 13A, the mirror driving unit 211 adjusts the orientations of the electric mirrors 212L and 212R in the reference viewing directions so that the electric mirrors 212L and 212R display the images in the reference viewing ranges 50L and 50R to the driver (step S401).

Next, the lane shape acquisition unit 11 acquires the information on the location of the subject vehicle from the vehicle location detection apparatus 33 (step S402).

Then, the lane shape acquisition unit 11 acquires the shape of the lane near the subject vehicle by referring to the map data acquired through access to the map data storage unit 32 based on the information on the location of the subject vehicle acquired in the step S402 (step S403). The lane near the subject vehicle herein refers to the lane in a range of 5 m from the subject vehicle, for example.

Next, the viewing range setting unit 12 acquires the shape of the lane near the subject vehicle and the information on the location of the subject vehicle from the lane shape acquisition unit 11, and determines, based on them, whether the subject vehicle is making a right or left turn at an intersection (step S404). The viewing range setting unit 12 determines whether the subject vehicle is making a turn based on whether the subject vehicle is entering into the intersection from a right turn lane or a left turn lane based on the information on the location of the subject vehicle or based on the turning angle of the subject vehicle acquired from the vehicle turning angle detection apparatus 35.

When the subject vehicle is making the right or left turn at the intersection in the step S404, the viewing range setting unit 12 sets the recommended viewing region in an entering lane into the intersection (step S405). The recommended viewing region is different from the recommended viewing range, and is a region in which an absolute location in the entering lane is set.

Next, the viewing range setting unit 12 sets a region including the recommended viewing region to the recommended viewing range (step S406). Specifically, the viewing range setting unit 12 acquires the turning angle of the subject vehicle at the intersection from the vehicle turning angle detection apparatus 35, and calculates an angle formed by the subject vehicle and the recommended viewing region from the turning angle of the subject vehicle. The viewing range setting unit 12 sets the recommended viewing range based on the angle formed by the subject vehicle and the recommended viewing region. When calculating the angle formed by the subject vehicle and the recommended viewing region, the viewing range setting unit 12 may set a certain point in the recommended viewing region to a representative point, and calculate an angle formed by the representative point and the subject vehicle.

On the other hand, when the subject vehicle is not making the right or left turn at the intersection in the step S404, the viewing range setting unit 12 sets the recommended viewing range based on the shape of the lane behind the subject vehicle (step S407). The recommended viewing range is herein set as described with reference to FIG. 12.

After the viewing range setting unit 12 sets the recommended viewing range in the step S406 or S407, the mirror driving unit 211 adjusts the orientations of the electric mirrors 212L and 212R in the recommended viewing directions in accordance with control of the mirror controller 13A (step S408).

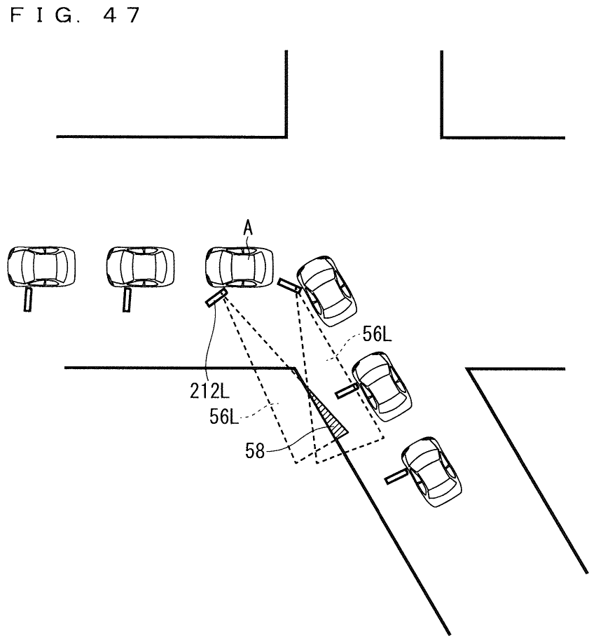

FIG. 47 illustrates a recommended viewing region 58 and the recommended viewing range of the electric mirror 212L when the subject vehicle A makes a left turn at an intersection. The orientation of the electric mirror 212L is always adjusted in the recommended viewing direction when the subject vehicle A makes the left turn at the intersection, so that the driver can always view the image in the recommended viewing region 58. The recommended viewing region 58 is set to a left end of the entering lane into the intersection, so that the driver can make sure that the subject vehicle A does not catch any vehicle, such as a motorcycle, traveling straight from behind the subject vehicle A when the subject vehicle A makes the left turn.

### Effects of Embodiment 9

In the lateral rear image control apparatus 109 in Embodiment 9, when the subject vehicle makes the right turn or the left turn at the intersection, the viewing range setting unit 12 sets, based on the information on the shape of the entering lane in which the subject vehicle travels when entering into the intersection, the recommended viewing region in the entering lane, and sets the recommended viewing range based on the angle formed by the subject vehicle and the recommended viewing region and the location of the subject vehicle. The driver can thus make sure that the subject vehicle does not catch any other vehicle when the subject vehicle makes the right or left turn.

<Hardware Configuration>

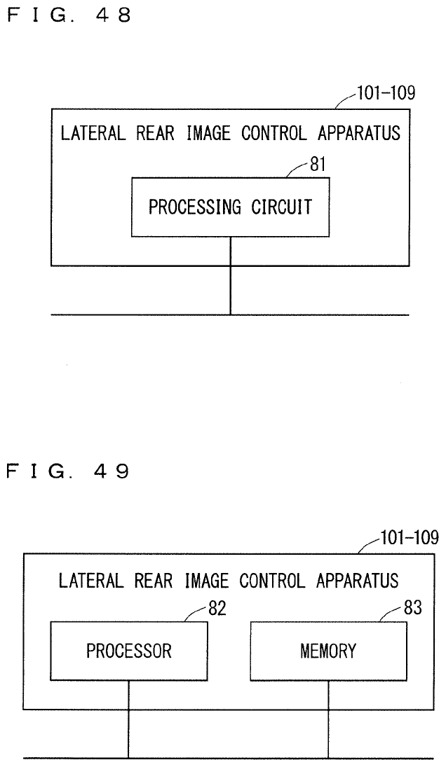

The lane shape acquisition unit 11, the viewing range setting unit 12, the controller 13, the mirror controller 13A, the camera controller 13B, and the cropping controller 13C in each of the above-mentioned lateral rear image control apparatuses 101 to 109 are achieved by a processing circuit 81 shown in FIG. 48. That is to say, the processing circuit 81 includes the lane shape acquisition unit 11, the viewing range setting unit 12, the controller 13, the mirror controller 13A, the camera controller 13B, and the cropping controller 13C (hereinafter, referred to as the “lane shape acquisition unit 11 and the like”). Dedicated hardware or a processor executing a program stored in memory may be applied to the processing circuit 81. The processor is a central processing unit, a processing unit, an arithmetic unit, a microprocessor, a microcomputer, a digital signal processor, or the like, for example.

In a case where the processing circuit 81 is dedicated hardware, the processing circuit 81 is a single circuit, a composite circuit, a programmed processor, a parallel-programmed processor, an application specific integrated circuit (ASIC), a field-programmable gate array (FPGA), or combinations thereof. A plurality of processing circuits 81 may achieve functions of the lane shape acquisition unit 11 and the like, or a single processing circuit may collectively achieve the functions.

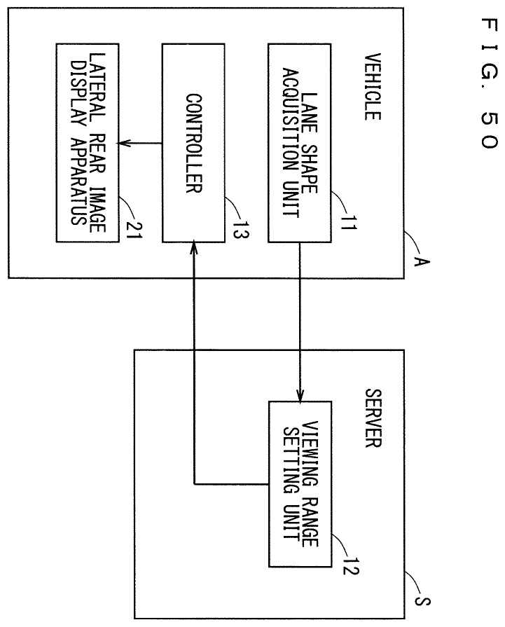

In a case where the processing circuit 81 is a processor, the functions of the lane shape acquisition unit 11 and the like are achieved by combination with software and the like (software, firmware, or software and firmware). The software and the like are described as a program, and stored in the memory. As shown in FIG. 49, a processor 82 applied to the processing circuit 81 reads and executes the program stored in memory 83 to achieve the functions of these units. That is to say, the lateral rear image control apparatuses 101 to 109 each include the memory 83 to store a program which, when executed by the processing circuit 81, results in performance of steps including: acquiring information on a shape of a travel lane of a subject vehicle; setting, based on the information on the shape of the travel lane behind the subject vehicle, a region located in a particular direction relative to the subject vehicle at a lateral rear of the subject vehicle to a recommended viewing range; and controlling a lateral rear image display apparatus so that an image in the recommended viewing range is displayed to a driver. In other words, the program causes a computer to perform procedures and methods performed by the lane shape acquisition unit 11 and the like. The memory 83 herein includes nonvolatile or volatile semiconductor memory, such as random access memory (RAM), read only memory (ROM), flash memory, erasable programmable read only memory (EPROM), and electrically erasable programmable read only memory (EEPROM), a hard disk drive (HDD), a magnetic disk, a flexible disk, an optical disc, a compact disc, a minidisc, a digital versatile disk (DVD), and a drive apparatus for them, or may be any storage medium used in the future.

A configuration in which the functions of the lane shape acquisition unit 11 and the like are achieved either by the hardware or by the software is described above. A configuration, however, is not limited to this configuration, and some of the lane shape acquisition unit 11 and the like may be achieved by dedicated hardware, and the other units may be achieved by software and the like. For example, a function of the viewing range setting unit 12 can be achieved by a processing circuit as the dedicated hardware, and functions of the other units can be achieved by the processing circuit 81 as the processor 82 reading and executing the program stored in the memory 83.

As described above, the processing circuit can achieve the above-mentioned functions by the hardware, the software, or a combination of them. The lateral rear image control apparatuses 101 to 109 are applicable not only to an in-vehicle apparatus but also to the in-vehicle apparatus, a portable navigation device (PND), a communication terminal (a mobile terminal, such as a mobile phone, a smartphone, and a tablet) as well as a function of an application installed on them and a system built by combining a server and the like as appropriate. In this case, the functions or the components of each of the lateral rear image control apparatuses 101 to 109 described above may be distributed to devices building the system or may be concentrated in any of the devices. FIG. 50 shows an example of the lateral rear image control apparatus 101 in Embodiment 1 configured by the subject vehicle A and a server S. The subject vehicle A includes the lane shape acquisition unit 11, the controller 13, and the lateral rear image display apparatus 21, and the server S includes the viewing range setting unit 12.

Embodiments and modifications of the present invention can freely be combined with each other, and can be modified or omitted as appropriate within the scope of the invention.

While the invention has been described in detail, the foregoing description is in all aspects illustrative and not restrictive. It is understood that numerous modifications not having been described can be devised without departing from the scope of the present invention.

### EXPLANATION OF REFERENCE SIGNS

11 lane shape acquisition unit, 12 viewing range setting unit, 13 controller, 13A mirror controller, 13B camera controller, 13C cropping controller, 21 to 29 lateral rear image display apparatus, 31 white line recognition apparatus, 32 map data storage unit, 33 vehicle location detection apparatus, 34 surrounding moving object detection apparatus, 35 vehicle turning angle detection apparatus, 44 mirror surface, 50L and 50R reference viewing range, 52L and 52R recommended viewing range, 81 processing circuit, 82 processor, 83 memory, 101 to 109 lateral rear image control apparatus, 211 mirror driving unit, 212L, 212R, and 213L electric mirror, 231 camera driving unit, 232L and 232R camera, 233L and 233R monitor, 441 first mirror surface, 442 second mirror surface.

1. A lateral rear image control apparatus controlling a lateral rear image display apparatus displaying an image at a lateral rear of a subject vehicle to a driver, the lateral rear image control apparatus comprising:
a processor to execute a program; and
a memory to store the program which, when executed by the processor, performs processes of:
acquire information on a shape of a travel lane of the subject vehicle;
setting, based on the information on the shape of the travel lane behind the subject vehicle, a region located in a particular direction relative to the subject vehicle at the lateral rear of the subject vehicle to a recommended viewing range; and
controlling the lateral rear image display apparatus so that an image in the recommended viewing range is displayed to the driver, wherein
the recommended viewing range includes a first recommended viewing point located a first distance behind a predetermined portion of the subject vehicle along the travel lane to maintain a location in a width direction of the travel lane and a second recommended viewing point located a second distance away from the first recommended viewing point in an outward direction relative to a direction of travel of the subject vehicle.

2. The lateral rear image control apparatus according to claim 1, wherein
the information on the shape of the travel lane includes information on curvature of the travel lane.

3. The lateral rear image control apparatus according to claim 1, wherein
the information on the shape of the travel lane includes information on a grade of the travel lane.

4. (canceled)

5. The lateral rear image control apparatus according to claim 1, wherein
the lateral rear image display apparatus includes an electric mirror of the subject vehicle, and
when executed by the processor, the program performs a process of
controlling an orientation of the electric mirror.

6. The lateral rear image control apparatus according to claim 1, wherein
the lateral rear image display apparatus includes:
an image capturing device to capture an image at the lateral rear of the subject vehicle; and
a monitor mounted on the subject vehicle to display the image captured by the image capturing device.

7. The lateral rear image control apparatus according to claim 6, wherein
when executed by the processor, the program performs a process of
controlling an image capturing direction of the image capturing device.

8. The lateral rear image control apparatus according to claim 6, wherein
the monitor displays an image acquired through cropping of the image captured by the image capturing device, and
when executed by the processor, the program performs a process of
controlling a cropping range of the captured image.

9. The lateral rear image control apparatus according to claim 8, wherein
the image capturing device comprises a plurality of cameras having different image capturing directions, and
the monitor displays an image acquired through cropping of an image acquired through combination of images captured by the plurality of cameras.

10. The lateral rear image control apparatus according to claim 1, wherein
when executed by the processor, the program performs a process of
acquiring the information on the shape of the travel lane based on a result of recognition of a white line recognition apparatus to recognize a white line of the travel lane.

11. The lateral rear image control apparatus according to claim 1, wherein
when executed by the processor, the program performs a process of
acquiring the information on the shape of the travel lane by referring to map data based on information on a location of the subject vehicle.

12. The lateral rear image control apparatus according to claim 11, wherein
the map data is data in which lane sections continuously having the same curvature are expressed by a sublink, and a shape of a lane is expressed as a set of sublinks.

13. The lateral rear image control apparatus according to claim 1, wherein
when executed by the processor, the program performs a process of
determining presence or absence of a moving object traveling behind the subject vehicle in a lane adjacent to the travel lane of the subject vehicle, and, when the moving object is present, setting a region including the moving object to the recommended viewing range.

14. The lateral rear image control apparatus according to claim 1, wherein
when executed by the processor, the program performs processes of:
setting, regardless of the information on the shape of the travel lane behind the subject vehicle, a region located in a particular direction relative to the subject vehicle at the lateral rear of the subject vehicle to a reference viewing range; and
controlling the lateral rear image display apparatus so that the image in the recommended viewing range and an image in the reference viewing range are displayed to the driver.

15-16. (canceled)

17. The lateral rear image control apparatus according to claim 5, wherein
the predetermined portion of the subject vehicle is the electric mirror.

18. A lateral rear image control apparatus controlling a lateral rear image display apparatus displaying an image at a lateral rear of a subject vehicle to a driver, the lateral rear image control apparatus comprising:
a processor to execute a program; and
a memory to store the program which, when executed by the processor, performs processes of:
acquiring information on a shape of a travel lane of the subject vehicle;
setting a part of a region at the lateral rear of the subject vehicle to a recommended viewing range based on setting rules different at a right or left turn at which the subject vehicle makes the right or left turn at an intersection and at normal times other than the right or left turn; and
controlling the lateral rear image display apparatus so that an image in the recommended viewing range is displayed to the driver, wherein
at the normal times, a region located in a particular direction relative to the subject vehicle at the lateral rear of the subject vehicle is set to the recommended viewing range based on the information on the shape of the travel lane behind the subject vehicle, and
at the right or left turn, based on information on a shape of an entering lane in which the subject vehicle travels when entering into the intersection, a region in which an absolute location in the entering lane is set is set to a recommended viewing region, and the recommended viewing range is set based on an angle formed by the subject vehicle and the recommended viewing region and a location of the subject vehicle.

19. The lateral rear image control apparatus according to claim 18, wherein
the lateral rear image display apparatus includes:
an image capturing device to capture an image at the lateral rear of the subject vehicle; and
a monitor mounted on the subject vehicle to display the image captured by the image capturing device,
the monitor displays an image acquired through cropping of the image captured by the image capturing device, and
when executed by the processor, the program performs a process of
controlling a cropping range of the captured image.

20. The lateral rear image control apparatus according to claim 18, wherein
when executed by the processor, the program performs a process of
acquiring the information on the shape of the travel lane by referring to map data based on information on a location of the subject vehicle.

21. The lateral rear image control apparatus according to claim 18, wherein
when executed by the processor, the program performs a process of
at the normal times, determining presence or absence of a moving object traveling behind the subject vehicle in a lane adjacent to the travel lane of the subject vehicle, and, when the moving object is present, setting a region including the moving object to the recommended viewing range.

22. A lateral rear image control method of controlling a lateral rear image display apparatus displaying an image at a lateral rear of a subject vehicle to a driver, the lateral rear image control method comprising:
acquiring information on a shape of a travel lane of the subject vehicle;
setting a part of a region at the lateral rear of the subject vehicle to a recommended viewing range based on setting rules different at a right or left turn at which the subject vehicle makes the right or left turn at an intersection and at normal times other than the right or left turn; and
controlling the lateral rear image display apparatus so that an image in the recommended viewing range is displayed to the driver, wherein
at the normal times, a region located in a particular direction relative to the subject vehicle at the lateral rear of the subject vehicle is set to the recommended viewing range based on the information on the shape of the travel lane behind the subject vehicle, and
at the right or left turn, based on information on a shape of an entering lane in which the subject vehicle travels when entering into the intersection, a region in which an absolute location in the entering lane is set is set to a recommended viewing region, and the recommended viewing range is set based on an angle formed by the subject vehicle and the recommended viewing region and a location of the subject vehicle.
